(19) United States
(12) Patent Application Publication
(10) Pub. No.: US 2017/0041961 A1
(43) Pub. Date: Feb. 9, 2017

(54) ADJUSTMENT OF MEDIUM ACCESS PARAMETERS BASED AT LEAST IN PART ON REVERSE LINK DELAY

(71) Applicant: QUALCOMM Incorporated, San Diego, CA (US)

(72) Inventors: Chao Zou, San Jose, CA (US); Srinivas Katar, Fremont, CA (US); Xiaolong Huang, San Jose, CA (US); Hao Zhu, San Jose, CA (US)

(21) Appl. No.: 14/819,207

(22) Filed: Aug. 5, 2015

(51) Int. Cl. H04W 74/08; H04L 12/807; H04W 24/08

(52) U.S. Cl. CPC H04W 74/0875; H04W 24/08; H04L 47/27; H04W 84/12

(57) ABSTRACT

Methods, systems, and devices are described for wireless communication. A wireless device may detect a delay in reverse link throughput. The wireless device may reduce the delay by modifying channel access parameters. In one aspect, the wireless device may adjust enhanced distributed channel access (EDCA) parameters. For example, the wireless device may modify contention window size (CW) and arbitration interframe spacing (AIFS). In some cases, the wireless device may instigate EDCA parameter adjustments in another wireless device in the wireless system (e.g., by sending an EDCA adjustment request message). The channel access adjustments may be triggered by detection of various conditions that are indicative of the reverse link delay. For example, the wireless device may monitor the communication of acknowledgments (ACKs) and adjust EDCA parameters if the ACKs are delayed. In other cases, the wireless device may adjust EDCA parameters based at least in part on multi-user (MU) communications.

### BACKGROUND

The following relates generally to wireless communication, for example to adjustment of medium access parameters based at least in part on reverse link delay.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), may include an access point (AP) that may communicate with one or more stations (STAs) or mobile devices. The AP may be coupled to a network, such as the Internet, and may enable a mobile device to communicate via the network (or communicate with other devices coupled to the access point in a service set, e.g., a basic service set (BSS) or extended service set (ESS)). A wireless device may communicate with a network device bi-directionally. For example, in a WLAN, a STA may communicate over a wireless medium with an associated AP via downlink (DL) and reverse link (UL). From the perspective of the STA, the DL (or forward link) may refer to the communication link from the AP to the STA, and the UL (or reverse link) may refer to the communication link from the STA to the AP. The wireless medium (e.g., a frequency channel) of the WLAN may be shared so that access to the medium is contention-based; that is, wireless devices in the WLAN (e.g., APs and STAs) may compete for the wireless medium. The wireless device that wins access to the medium may transmit over the medium. Other wireless devices that wish to transmit may wait until the next opportunity to contend for the medium.

A STA may also have data ready to send but may not be able to access a wireless medium to perform the transmission. For example, the STA may continually fail to transmit data due to high traffic on a medium shared with other wireless devices. In such instances, the inability of the STA to access the shared medium may result in delayed reverse link data, which in turn may impair system throughput and decrease system performance.

### SUMMARY

Systems, methods, and apparatuses for adjustment of medium access parameters based at least in part on reverse link delay are described. In a wireless communication system, a wireless device may experience delay in reverse link throughput. The wireless device may reduce the delay by modifying channel access parameters to increase access to the shared medium. The wireless device may adjust enhanced distributed channel access (EDCA) parameters. For example, the wireless device may modify interframe space (IFS) parameters such as contention window (CW) size and arbitration interframe spacing (AIFS). The wireless device may also instigate EDCA parameter adjustments in another wireless device in the wireless system (e.g., by sending and EDCA adjustment request message). The actions of the wireless device may be triggered by detection of various conditions that are indicative of the reverse link delay. For example, the wireless device may monitor the communication of acknowledgments (ACKs) and adjust EDCA parameters if the ACKs are delayed. The wireless device may also adjust EDCA parameters based at least in part on a multi-user (MU) communication.

A method of wireless communication is described. The method may include detecting a condition indicative of a delay in reverse link throughput with respect to forward link throughput associated with a first wireless device, and adjusting, based at least in part on the detected condition, an enhanced distribution channel access (EDCA) parameter associated with a wireless device selected from a group consisting of: the first wireless device and a second wireless device.

A communication device for wireless communication is described. The communication device may include a delay condition detector for detecting a condition indicative of a delay in reverse link throughput with respect to forward link throughput associated with a first wireless device, and an EDCA parameter coordinator for adjusting, based at least in part on the detected condition, an enhanced distribution channel access (EDCA) parameter associated with a wireless device selected from a group consisting of: the first wireless device and a second wireless device.

An apparatus for wireless communication is described. The apparatus may include means for detecting a condition indicative of a delay in reverse link throughput with respect to forward link throughput associated with a first wireless device, and means for adjusting, based at least in part on the detected condition, an enhanced distribution channel access (EDCA) parameter associated with a wireless device selected from a group consisting of: the first wireless device and a second wireless device.

In some examples of the method, communication device, or apparatus described herein, detecting the condition includes processing an EDCA parameter adjustment request based at least in part on the delay in reverse link throughput with respect to forward link throughput associated with the first wireless device. Additionally or alternatively, in some examples detecting the condition includes exchanging a multi-user transmission, wherein the multi-user transmission triggers adjusting the EDCA parameter.

In some examples of the method, communication device, or apparatus described herein, detecting the condition includes monitoring a size of a transmission queue associated with the first wireless device, wherein adjusting the EDCA parameter is based at least in part on the size of the transmission queue. Additionally or alternatively, in some examples detecting the condition includes detecting a delay in an acknowledgement message from the wireless device.

In some examples of the method, communication device, or apparatus described herein, adjusting the EDCA parameter includes adjusting a contention window parameter for the wireless device. Additionally or alternatively, in some examples adjusting the contention window parameter includes adjusting a maximum contention window size for the wireless device.

In some examples of the method, communication device, or apparatus described herein, adjusting the contention window parameter includes adjusting a minimum contention window size for the wireless device. Additionally or alternatively, in some examples adjusting the EDCA parameter includes adjusting an arbitration inter-frame spacing (AIFS) parameter for the first wireless device, wherein the AIFS indicates a period of time between a first transmission and a second transmission by the first wireless device.

In some examples of the method, communication device, or apparatus described herein, the AIFS parameter comprises an arbitration inter-frame space number (AIFSN). Additionally or alternatively, in some examples adjusting the EDCA parameter includes providing the adjusted EDCA parameter to the wireless device, and providing a second adjusted EDCA parameter to a third wireless device, wherein the second adjusted EDCA parameter is different from the adjusted EDCA parameter.

Some examples of the method, communication device, or apparatus described herein may further include processes, features, means, or instructions for modifying, based at least in part on the detected condition, a short inter-frame space (SIFS) bursting parameter associated with the wireless device.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) for adjustment of medium access parameters based at least in part on reverse link delay configured in accordance with various aspects of the present disclosure

FIG. 2 illustrates an example of a wireless communications subsystem that supports adjustment of medium access parameters based at least in part on reverse link delay in accordance with various aspects of the present disclosure;

FIG. 3 illustrates an example of a wireless communications subsystem that supports adjustment of medium access parameters based at least in part on reverse link delay in accordance with various aspects of the present disclosure;

FIG. 4 illustrates an example of a interframe spacing diagram that supports adjustment of medium access parameters based at least in part on reverse link delay in accordance with various aspects of the present disclosure;

FIG. 5A illustrates an example of a process flow that supports adjustment of medium access parameters based at least in part on reverse link delay in accordance with various aspects of the present disclosure;

FIG. 5B illustrates another example of a process flow that supports adjustment of medium access parameters based at least in part on reverse link delay in accordance with various aspects of the present disclosure;

FIG. 5C illustrates yet another example of a process flow that supports adjustment of medium access parameters based at least in part on reverse link delay in accordance with various aspects of the present disclosure;

FIG. 6 illustrates an example of a process flow that supports adjustment of medium access parameters based at least in part on reverse link delay in accordance with various aspects of the present disclosure;

FIG. 7 illustrates an example of a process flow that supports adjustment of medium access parameters based at least in part on reverse link delay in accordance with various aspects of the present disclosure;

FIG. 8 shows a block diagram of a wireless device that supports adjustment of medium access parameters based at least in part on reverse link delay in accordance with various aspects of the present disclosure;

FIG. 9 shows a block diagram of a wireless device that supports adjustment of medium access parameters based at least in part on reverse link delay in accordance with various aspects of the present disclosure;

FIG. 10A illustrates a block diagram of a system including a station (STA) that supports adjustment of medium access parameters based at least in part on reverse link delay in accordance with various aspects of the present disclosure;

FIG. 10B illustrates a block diagram of a system including a STA that supports adjustment of medium access parameters based at least in part on reverse link delay in accordance with various aspects of the present disclosure;

FIG. 11A illustrates a block diagram of a system including an access point (AP) that supports adjustment of medium access parameters based at least in part on reverse link delay in accordance with various aspects of the present disclosure;

FIG. 11B illustrates a block diagram of a system including an AP that supports adjustment of medium access parameters based at least in part on reverse link delay in accordance with various aspects of the present disclosure;

FIG. 12 illustrates a method for adjustment of medium access parameters based at least in part on reverse link delay in accordance with various aspects of the present disclosure;

FIG. 13 illustrates a method for adjustment of medium access parameters based at least in part on reverse link delay in accordance with various aspects of the present disclosure;

FIG. 14 illustrates a method for adjustment of medium access parameters based at least in part on reverse link delay in accordance with various aspects of the present disclosure; and

FIG. 15 illustrates a method for adjustment of medium access parameters based at least in part on reverse link delay in accordance with various aspects of the present disclosure.

### DETAILED DESCRIPTION

A wireless device may detect a delay in reverse link throughput and reduce the delay by altering channel access parameters. The altered channel access parameters may increase channel access for the wireless device experiencing the delay. The wireless device that detects the delay may be the wireless device that alters channel access parameters; in other cases, the wireless device that detects the delay may instruct other wireless devices to adjust channel access parameters. The wireless device that adjusts channel access parameters may modify enhanced distributed channel access (EDCA) parameters such as contention window (CW) size and arbitration interframe spacing (AIFS). In some cases, adjusting channel access parameters may include adjusting short interframe spacing (SIFS) bursting parameters. The wireless device may trigger channel access parameter adjustments based at least in part on a condition indicative of reverse link delay. For example, the wireless device may detect that there is a lag in acknowledgments corresponding to multi-user (MU) transmissions. In some cases, the wireless device may adjust channel access parameters if an MU communication is detected. These and other aspects of the disclosure are further illustrated by and described with reference to apparatus diagrams, system diagrams, and flowcharts that relate to adjustment of medium access parameters based at least in part on reverse link delay.

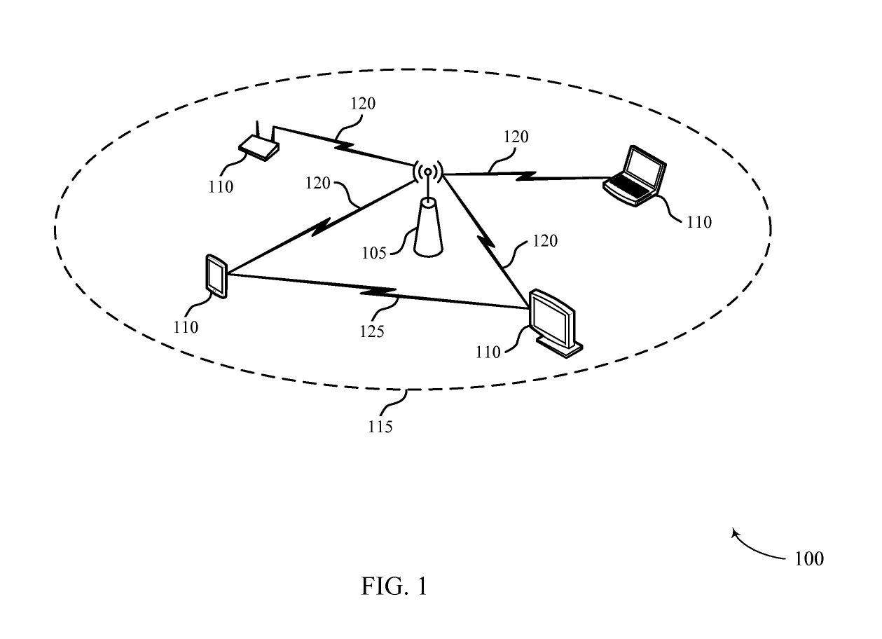

FIG. 1 illustrates a wireless local area network (WLAN) 100 configured in accordance with various aspects of the present disclosure. The WLAN 100 includes an AP 105 and multiple associated STAs 110, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 110 may represent a basic service set (BSS) or an extended service set (ESS). The various STAs 110 in the network are able to communicate with one another through the AP 105. Also shown is a coverage area 115 of the AP 105, which may represent a basic service area (BSA) of the WLAN 100.

Although not shown in FIG. 1, a STA 110 may be located in the intersection of more than one coverage area 115 and may associate with more than one AP 105. A single AP 105 and an associated set of STAs 110 may be referred to as a BSS. An ESS is a set of connected BSSs. A distribution system (DS) (not shown) may be used to connect APs 105 in an ESS. In some cases, the coverage area 115 of an AP 105 may be divided into sectors (also not shown). The WLAN 100 may include APs 105 of different types (e.g., metropolitan area, home network, etc.), with varying and overlapping coverage areas 115. Two STAs 110 may also communicate directly via a direct wireless link 125 regardless of whether both STAs 110 are in the same coverage area 115. Examples of direct wireless links 125 may include Wi-Fi Direct connections, Wi-Fi Tunneled Direct Link Setup (TDLS) links, and other group connections. STAs 110 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within WLAN 100.

WLAN 100 implements a contention-based protocol that allows a number of wireless devices (e.g., STAs 110 and APs 105) to share the same wireless medium (e.g., a channel) without pre-coordination. In a contention-based wireless system, wireless devices may attempt to access a common channel in an unscheduled manner. To prevent several wireless devices from transmitting over the channel at the same time and therefore interfering with one another, and to ensure certain quality of service (QoS) standards, each wireless device in a BSS may operate according to certain procedures that structure and organize medium access. That is, each wireless device may implement the same coordination techniques according to a common channel access protocol. For example, the wireless devices of WLAN 100 implements EDCA, which defines channel access rules for a shared medium. Thus, the wireless devices may each contend or compete for a medium according to the rules defined by EDCA.

Wireless devices that implement EDCA have associated EDCA parameters. The EDCA parameters may provide certain channel access restrictions that are specific to each wireless device. For example, interframe spacing (IFS) parameters for a wireless device may dictate how long a wireless device may wait after a frame to communicate. One example of an IFS is the distributed coordination function (DCF) interframe spacing (DIFS). The DIFS duration specifies how long a channel must be free of traffic (idle) before a wireless device permitted to transmit over the channel. Different IFS may be used according to the type of communication in which the wireless device intends to engage. In some cases, the EDCA parameters for a wireless device are based at least in part on the priority (access category) of the wireless device. The access category for a wireless device may be dynamically determined, and may be based at least in part on the type of traffic the wireless device wishes to communicate. For example, a wireless device that has voice data may be assigned a higher access category than a wireless device that has email data. The EDCA parameters assigned to a high priority device may increase the likelihood of channel access for the high priority device compared to a low priority wireless devices. In one example, a high priority wireless device are assigned an EDCA parameter that enables the wireless device to contend sooner after a frame than a low priority wireless device. That is, an IFS for a high priority device may be shorter than an IFS for a low priority device.

As described above, wireless devices in a contention-based channel access system may share a single channel for transmissions. The channel may be a half-duplex channel in which one wireless device may transmit at a time (i.e., traffic may flow in one of two directions at a time). Collisions may occur when two or more wireless devices attempt to access the channel at the same time. When a collision occurs, a wireless device that does not currently own the channel may experience a transmission failure. To reduce collisions, wireless devices may attempt to access the channel according to the IFS parameters to which the wireless device are assigned. For example, according to EDCA, a wireless device contends for the channel when the wireless device has data ready to send. To avoid a collision, the wireless device may determine if the channel is available (e.g., the wireless device may utilize carrier sense multiple access with collision avoidance (CSMA/CA)) before transmitting. If the channel is continuously free of traffic for a DIFS duration, the wireless device is permitted to use the channel to transmit a frame. On the other hand, if the wireless device determines that the channel is busy (i.e., in use by another wireless device) during the DIFS duration, the wireless device may defer transmission. In other words, the wireless device may wait a number of times slots (e.g., a backoff duration) before transmitting.

The backoff duration may be based at least in part on the contention window of the wireless device, which may be dynamically adjusted according to collisions. Both the backoff duration and the CW may be examples of EDCA parameters. The backoff duration may be a value randomly selected from a range between 0 and the CW. The CW may be dynamically modified based at least in part on the result of a transmission attempt by the wireless device. For an initial transmission attempt, the CW may be set to a value called the contention window minimum (CWmin). Thus, for an initial transmission attempt, the backoff may be selected between 0 and CWmin. Once the backoff time has elapsed, the wireless device may transmit immediately. If the channel is busy (e.g., there is a collision), the CW may be increased (e.g., doubled) for each subsequent retransmission attempt until a maximum contention window value is reached (CWmax) or the transmission is successful. In some cases, a wireless device detects a delay in reverse link data and adjust CW parameters (e.g., CWmin, CWmax). For instance, the wireless device may decrease CWmin so that the wireless device may wait less time prior to transmitting over the channel. The CW parameter adjustment may also be performed prior to, or after, a collision.

After a wireless device gains access to a shared channel, the wireless device may transmit traffic in frames over the channel. However, different types of traffic may have different priority levels (e.g., control may be prioritized over data). In EDCA, traffic-type prioritization is enabled by varying the IFS for different traffic types (e.g., high priority traffic types may have smaller IFS compared with low priority traffic types). For instance, a STA 110 may wait a short interframe space (SIFS) duration after a receiving a frame before transmitting an ACK. The SIFS duration may be less than that of a DIFS duration. Thus, the STA 110 that received the frame (and wishes to send an ACK) may contend for the channel before other wireless devices (e.g., wireless devices that detected the channel was busy during the frame and waited a DIFS duration before contending).

A STA 110 may wait an arbitration interframe spacing (AIFS) time interval between transmission of one frame and subsequent data frame. For example, after transmitting an ACK, a STA 110 may wait an AIFS duration before transmitting another frame. An AIFS for a wireless device may be dynamically determined based at least in part on the content of the data to be transmitted. That is, AIFS may be used to prioritize access categories, such as giving voice data priority over email data. By expanding or shortening the period of time a wireless device waits before it is permitted to transmit a next frame, the AIFS may dictate which wireless device wins contention. For example, a wireless device assigned a shorter AIFS period may have an increased probability of transmitting the data with low latency. The AIFS duration may be based at least in part on the SIFS and/or an AIFS-number (AIFSN), which indicates a number of time slots. The AIFSN for a wireless device may be dynamically determined. For example, a STA 110 may detect a delay in reverse link throughput and decrease the AIFSN to enable faster turn-around for contention.

In some cases, a STA 110 monopolizes the shared channel for a period of time by implementing SIFS bursting. For example, the STA 110 may transmit multiple A-MPDUs (aggregated MAC protocol data units) without relinquishing control of the medium. During SIFS bursting, the STA 110 may only wait a SIFS duration between each transmitted frame. That is, the AIFS duration may equal to the SIFS duration (i.e., the AIFSN may be set to zero). Because a SIFS duration may be less than a DIFS, the STA 110 may be guaranteed sole access to the channel during the SIFS bursting. The period of time for which the STA 110 is permitted to practice SIFS bursting may be dynamically determined. For example, a STA 110 may detect a delay a large amount of ACKs in a transmission queue and increase the SIFS bursting duration, thereby generating an opportunity to transmit the pending ACKs.

WLAN 100 may increase throughput and reliability by supporting certain transmission techniques such as multiple-input-multiple-output (MIMO) and multi-user (MU) MIMO. A MIMO communication involves multiple transmitter antennas (e.g., at an AP 105) sending a signal to multiple receive antennas (e.g., at a STA 110). Each transmitting antenna may transmit independent data (or spatial) streams which may increase diversity and the likelihood successful signal reception. In other words, MIMO techniques use multiple antennas on an AP 105 or multiple antennas on a STA 110 to take advantage of multipath environments to transmit multiple data streams. In some cases, an AP 105 may implement multi-user MIMO (MU-MIMO) transmissions in which the AP 105 simultaneously transmits independent data streams to multiple STAs 110. For example, in an MU-N transmission, an AP 105 may simultaneously transmit signals to N STAs. Thus, when an AP 105 has traffic for many STAs 110, the AP 105 may increase network throughput by aggregating individual streams for each STA 110 into a single MU-MIMO transmission.

During propagation, a signal (e.g., a MU-MIMO signal) may experience environmental factors that affect signal integrity. For example, the propagation path of a signal may be such that the signal encounters less than ideal channel conditions (e.g., the signal may be subject to interference and noise). Such channel condition factors may adversely affect the signal (e.g. through attenuation), thereby causing the signal to be unsuccessfully received by the intended target (e.g., a wireless device such as a STA 110). Thus, a wireless system may implement techniques and methods for increasing the likelihood of successful signal reception. For example, WLAN 100 may employ acknowledgment messages that indicate to a transmitting device (e.g., an AP 105) the reception status of a signal message at a receiving device (e.g., a STA 110). For example, if the transmitted message is not properly received, the receiving device may send a negative acknowledgement (NACK) to the transmitting device indicating the failure. Upon reception of the NACK, the transmitting device may resend a version of the message. However, if the transmitted message is successfully received, the receiving device may send an acknowledgment (ACK) back to the transmitting device. Upon reception of the ACK, the transmitting device may refrain from sending a redundant version of the message.

In some cases, a STA 110 may successfully receive a message from an AP 105 and prepare an ACK for transmission. However, due to congestion in the WLAN 100 (i.e., high traffic conditions), the STA 110 may fail to gain access the wireless medium. Accordingly, the STA 110 may not be able to transmit the queued ACK (i.e., reverse link throughput may be delayed). A delay in ACK transmission may have negative consequences for forward link throughput. For example, after an AP 105 sends an MU-N transmission, the AP 105 may refrain from sending a subsequent MU-N transmission until N ACKs are received from the associated N STAs 110. However, if the AP 105 only receives N−1 ACKs (e.g., due to reverse link throughput delay), the AP 105 may resort to transmitting MU-N−1 transmissions until the Nth ACK is received. Thus, delayed reverse link data (e.g., ACKs) may decrease the density of MU-N transmissions, and consequently reduce system efficiency and throughput.

In another example, delay in reverse link throughput (e.g., ACKs) may affect the efficiency of AP 105 by reducing the length of forward link transmissions. For example, the medium access control (MAC) layer may construct AMPDUs for transmission using physical layer convergence protocol data units (PPDUs) aggregated at a firmware buffer. The firmware buffer may aggregate the PPDUs from transmission control protocol (TCP) packets received from a higher layer packet sender. However, in some cases the higher layer may not send enough TCP packets to the firmware buffer for the firmware buffer to generate long PPDUs. For example, the TCP packet sender may not send a TCP packet to the firmware buffer until an ACK is received for the TCP packet. Thus, when reverse link throughput delay increases the latency of ACKs, the AP 105 may resort to sending short PPDUs (due to insufficient TCP packets at the firmware buffer), thereby reducing MAC efficiency. To summarize, delays in reverse link throughput may negatively impact system efficiency and throughput.

Accordingly, wireless devices in WLAN 100 may implement techniques to detect conditions indicative of delay in reverse link throughput. Based at least in part on the detection of the conditions of delay, wireless devices in WLAN 100 may adjust channel access parameters to reduce or eliminate the delay. For instance, one or more wireless devices across WLAN 100 may adjust channel access parameters to increase the likelihood of channel access for a wireless device experiencing reverse link delay. In some aspects, EDCA parameters are modified so that medium access is more readily achieved by a wireless device with delayed data. For example, the wireless device experiencing the reverse link delay may adopt more aggressive EDCA parameters (e.g., EDCA parameters that increase the likelihood of the wireless device gaining access to the channel), while other wireless devices in the WLAN (e.g., wireless devices not experiencing the reverse link delay) may adopt less aggressive EDCA parameters (e.g., EDCA parameters that decrease the likelihood of gaining access to the channel).

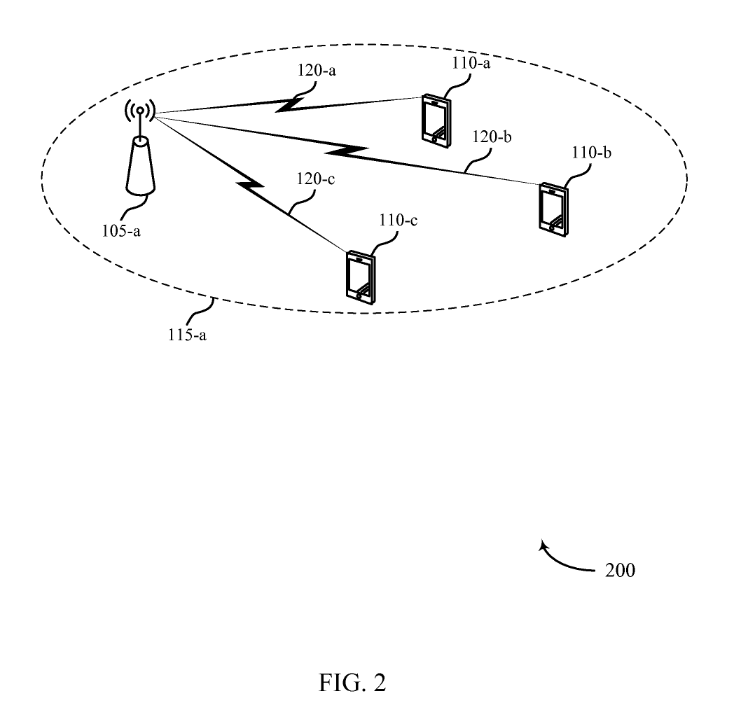

FIG. 2 illustrates a wireless communications subsystem 200 that supports adjustment of medium access parameters based at least in part on reverse link delay in accordance with various aspects of the present disclosure. Wireless communications subsystem 200 may facilitate reduced delays in reverse link transmissions in a contention-based environment. Wireless communications subsystem 200 may also provide techniques for detection of reverse link delay and modification of channel access parameters (e.g., EDCA parameters). Wireless communications subsystem 200 may include AP 105-a, STA 110-a, STA 110-b, STA 110-c, and coverage area 115-a each of which may be an example of a wireless device described herein, and with reference to FIG. 1.

AP 105 may exchange information (e.g., control and data) with STAs 110-a, 110-b, 110-c via communication links 120-a, 120-b, 120-c, respectively. The wireless devices of wireless communications subsystem 200 may share the same medium for communication. That is, AP 105-a and STAs 110-a, 110-b, 110-c may use a single channel for communication. The wireless devices may gain access to the shared channel according to EDCA as described with reference to FIG. 1. In one scenario, AP 105-a may win contention and transmit an MU-3 transmission to STAs 110-a, 110-b, 110-c. Each STA 110 may successfully receive the MU-3 transmission and generate respective ACKs. In some cases, STA 110-c may unsuccessfully attempt to transmit an ACK to AP 105-a due to failed contention. For example, STA 110-c may contend for the channel during a period of time when STA 110-a is transmitting an ACK. If STA 110-c continues to be denied access to the channel, reverse link data may be stalled and forward link throughput may suffer (e.g., AP 105-a may opt to transmit MU-2 transmissions instead of MU-3 transmissions).

In some cases, the wireless communications subsystem 200 prevents or reduces ACK delays by pseudo-scheduling the ACKs for each STA 110 according to a staggered timing configuration. That is, each STA 110 may be assigned EDCA parameters that offset the contention of each STA 110 so that each STA 110 contends for the channel at a different time. In one implementation, the STAs 110 may share a common CWmin and CWmax but may be assigned different AIFSNs. For example, in an MU-N transmission, if the AIFSN for the AP is 2*N+1, the AIFSN for STA N may be 2*N−1. Accordingly, in the present MU-3 example, STA 110-a may be assigned an AIFSN of 1, STA 110-b may be assigned an AIFSN of 3, and STA 110-c may be assigned an AIFSN of 5. If the common CWmin and CWmax are both equal to 1 (i.e., CW=1), the maximum total back off time possible for each STA may be AIFSN+CW. That is, the backoff time for STA 110-a may be 2 time slots, the backoff time for STA 110-b may be 4 time slots, and the backoff time for STA 110-c may be 6 time slots. Thus, the STAs 110 may contend for the channel asynchronously such that the contention of each STA 110 does not coincide. In some cases, the EDCA parameters for a STA 110 are based at least in part on the position of the STA 110 within the MU-N transmission group. For example, a STA 110 in position 1 of the MU-N group may be assigned more aggressive EDCA parameters than other STAs 110 in the MU-N group. In certain scenarios, an AP 105 may promote a STA 110 that is experiencing reverse link delay to a higher position in an MU-N group.

Although described with reference to common (i.e., shared) CWmin and CWmax, the contention staggering scheme may be implemented using CWmin and CWmax that differ for one or more STAs 110 within the MU-N group. Moreover, the EDCA parameters CWmin, CWmax, and AIFSN may be dynamically updated to modify the order in which the STAs 110 attempt to access the channel. The staggered ACK configuration may be preemptively implemented (pre-configured prior to detection of delay) or implemented in response to detected reverse link delay (dynamically configured).

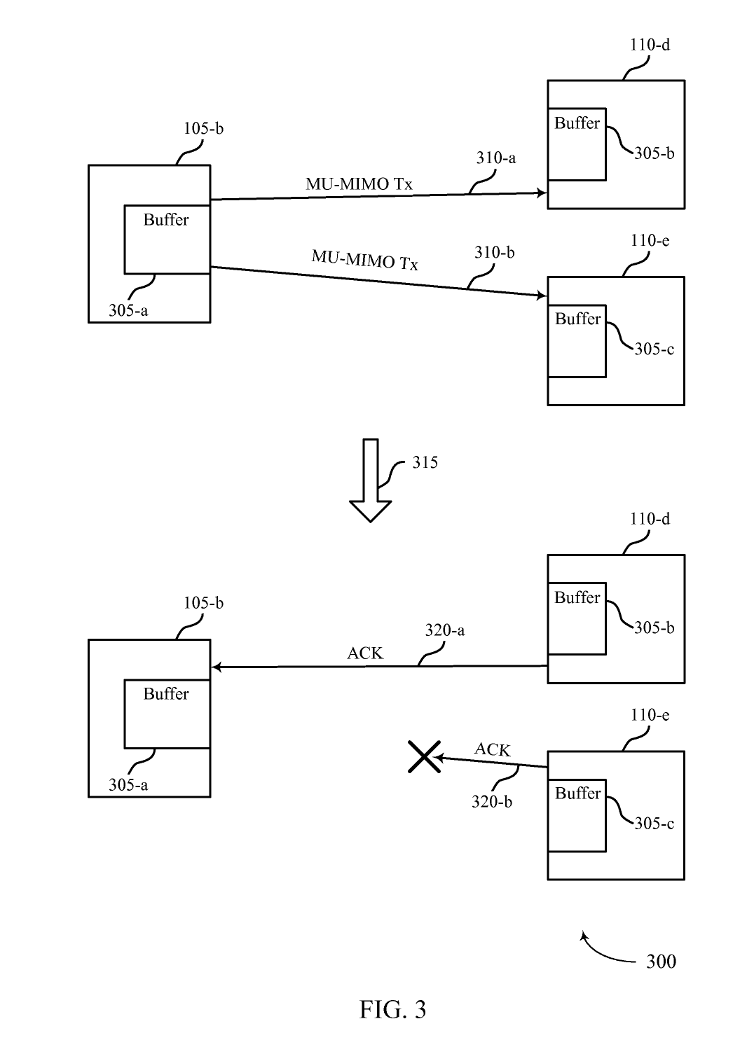

FIG. 3 illustrates a wireless communication subsystem 300 that supports adjustment of medium access parameters based at least in part on reverse link delay in accordance with various aspects of the present disclosure. Wireless communication subsystem 300 may facilitate the detection of delayed reverse link data and adjust channel access parameters to reduce the delay. Wireless communication subsystem 300 may include AP 105-b, STA 110-d, and STA 110-e, each of which may implement the features of a wireless device described herein and with respect to FIGS. 1 and 2. The wireless devices of wireless communication subsystem 300 may support MU-MIMO transmissions and access a shared channel according to EDCA. Additionally, each wireless device may include a buffer 305 which may serve as temporary storage for queued data packets (e.g., data packets ready to be transmitted). Each wireless device may monitor respective buffer queues and communications to detect conditions indicative of delay in reverse link throughput with respect to forward link throughput.

AP 105-b may generate an MU-N transmission if the MAC layer has data ready for more than one STA 110, where N is the number of STAs receive the transmission. For example, if the MAC layer has available data for STA 110-d and STA 110-e, AP 105-b may generate an MU-2 transmission with data for STA 110-d and STA 110-e. Thus, STA 110-d may receive data conveyed by a spatial stream associated with MU-MIMO transmission (Tx) 310-a and STA 110-e may receive data conveyed by a spatial stream associated with MU-MIMO Tx 310-b. In some cases, AP 105-b determines whether there is sufficient MAC data for an MU-2 transmission by monitoring client (i.e., STA 110) queues within buffer 305-a. In another aspect, AP 105-b monitors ACKs from the STAs 110 to determine the viability of an MU-2 transmission.

After reception of the MU-2 transmission, STA 110-d and STA 110-e may each generate ACKs for the successfully received data conveyed by the MU-N transmission. The ACKs for each STA 110 may be queued in each buffer 305 for transmission to AP 105-b. That is, STA 110-d may queue pending ACKs in buffer 305-b and STA 110-e may queue pending ACKs in buffer 305-c.

Subsequent to reception of the MU-2 transmission and the generation of corresponding ACKs, each STA 110 may contend 315 for access to the channel. STA 110-d may win contention and transmit an ACK 320-a to AP 105-b. Accordingly, STA 110-e may lose contention and fail to send an ACK 320-b to AP 105-b. Thus, reverse link data for STA 110-e may be delayed due to limited access to the channel for transmissions. In some cases, the delay in ACK 320-b may result in AP 105-b having insufficient MAC data for a subsequent MU-2 transmission. In such a scenario, AP 105-b may wait for ACK 320-b, delaying forward link transmissions, or proceed with an single user (SU) transmission for STA 110-d, thereby reducing forward link throughout.

In certain aspects, the delay in reverse link ACK 320-a may be detected and serve as an impetus for modification of channel access parameters. For example, the EDCA parameters for one or more of the wireless devices in wireless communication subsystem 300 may be modified to facilitate channel access for STA 110-e. In certain examples, the EDCA parameters associated with wireless devices not included in wireless communication subsystem 300 (e.g., other wireless devices in the same BSS (not shown)) may be adjusted based at least in part on the reverse link delay. Detection of a condition indicative of delay may be performed by AP 105-b, STA 110-e, or the network associated with wireless communication subsystem 300. In one example, AP 105-b may detect the delay by determining that there is insufficient data for a transmission to STA 110-e. For instance, AP 105-b may monitor the client queues within buffer 305-a for STA 110-e data. Additionally or alternatively, AP 105-b may monitor the ACKs from each STA 110 and detect the delay based at least in part on a delay in ACKs from STA 110-e.

The detection of insufficient data for STA 110-e may trigger dynamic adjustments to EDCA parameters of wireless devices included within, or without, wireless communication subsystem 300. That is, based at least in part on the detected delay, AP 105-b may adjust EDCA parameters associated with AP 105-b, STA 110-d, or STA 110-e. For example, AP 105-b may send a request message to STA 110-d indicating that STA 110-d may use less aggressive EDCA parameters, thereby increasing the likelihood that STA 110-e will win access to the channel. Additionally or alternatively, AP 105-b may send a request message to STA 110-e indicating that STA 110-e may use more aggressive EDCA parameters. For example, AP 105-b may send a request message that assigns a smaller CWmin size for STA 110-e. In certain scenarios, AP 105-b may modify its own EDCA parameters to increase the likelihood of channel access for STA 110-e. The modification of the EDCA parameters of AP 105-b may be triggered by reverse link delay, as described above, or based at least in part on a request from STA 110-e. AP 105-b may adjust EDCA parameters by modifying CWmin or CWmax. For example, AP 105-b increases CWmin so that AP 105-b waits longer after a collision to contend for the channel. In certain instances, AP 105-b ceases SIFS bursting.

In some cases, AP 105-b modifies EDCA parameters based at least in part on the duration of MU-N transmissions. For example, after AP 105-b sends MU-2 transmissions for a duration greater than a certain threshold, AP 105-b may trigger adjustments to the EDCA parameters of one or more wireless devices associated with AP 105-b. In certain scenarios, adjustments to EDCA parameters may be based at least in part on the number of wireless devices sharing the channel, or congestion on the channel. In certain cases, adjusting EDCA parameters may increase the likelihood of collisions. Thus, AP 105-b may implement various techniques to reduce the increased likelihood of collisions. For example, AP 105-b may limit or restrict the number of STA 110 that adjust EDCA parameters. In another aspect, AP 105-b may set a minimum threshold for CWmin. Additionally or alternatively, AP 105-b may provide different STAs 110 with different EDCA parameters.

In certain aspects, a condition indicative of delay in reverse link transmissions may be detected by STA 110-e. In one example, STA 110-e may detect a large amount of pending ACKs intended for AP 105-b. For example, STA 110-e may monitor the queues of buffer 305-c and detect an accumulation of pending ACKs. Based at least in part on the detected accumulation, STA 110-e may adjust EDCA parameters. For instance, STA 110-e may adopt more aggressive EDCA parameters to increase channel access. In certain aspects, STA 110-e EDCA parameter modifications may be triggered based at least in part on the duration of MU-N transmissions from AP 105-b. For instance, STA 110-e may trigger EDCA parameter adjustments when STA 110-e receives MU-2 transmissions for a duration of time greater than a threshold. The threshold may be static or dynamically determined and may be set by STA 110-e or AP 105-b.

In summary, EDCA parameter adjustments may be triggered by either an AP 105 or a STA 110. The triggering may be based at least in part on a wireless device noticing one or more conditions indicative of reverse link throughput delay with respect to forward link throughput. The EDCA parameter adjustments may be performed by the same device that detects the delay in reverse link data or by a different device (i.e., the network may coordinate dynamic medium access). In certain cases, EDCA parameters may be adjusted pre-emptively (before a delay in reverse link throughput is detected). For example, channel access parameter modification may be prompted by conditions pre-determined to be associated with reverse link delay. Although described with respect to a single buffer 305 per wireless device, the techniques described herein may be implemented in conjunction with any number of buffers (i.e., the processes are irrespective of the number of buffers), any of which may reside at any layer (e.g., a firmware buffer). Additionally, the techniques described herein may be implemented by wireless devices irrespective of the use of MU-MIMO communications.

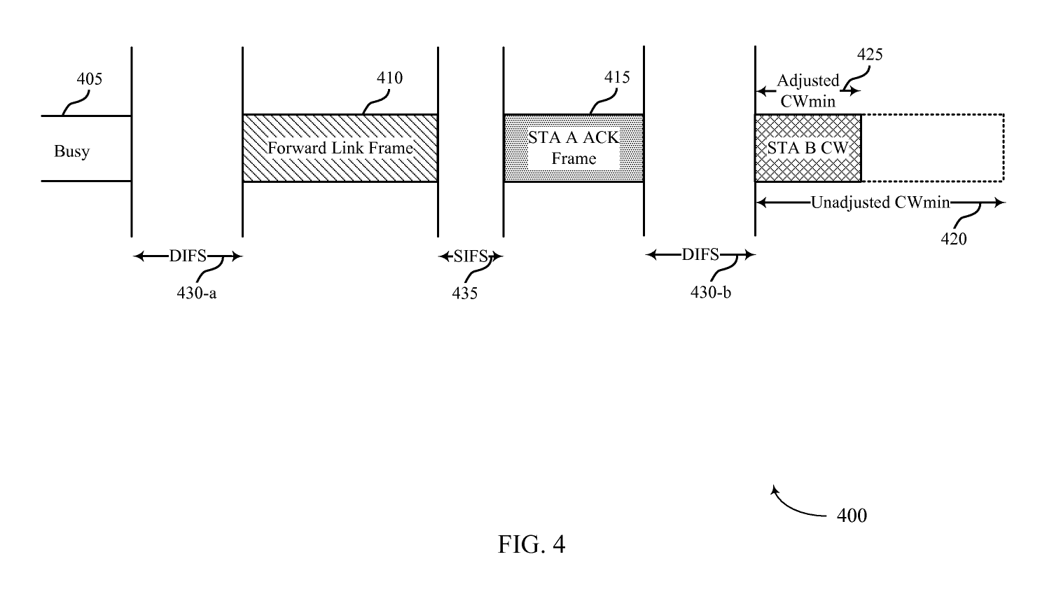

FIG. 4 illustrates an example of a interframe spacing diagram 400 that supports adjustment of medium access parameters based at least in part on reverse link delay in accordance with various aspects of the present disclosure. Interframe spacing diagram 400 illustrates an example of EDCA channel access timing for wireless devices (e.g., an AP 105 and STA 110) that share a common channel. Interframe spacing diagram 400 enables features of EDCA parameter adjustments, such as CW modifications.

Frame 405 may be a frame transmitted by a wireless device over a half-duplex channel shared by multiple wireless devices. Thus, each wireless device that performs a traffic check (e.g., implements CSMA/CA) for the channel during frame 405 may determine that the channel is busy. Accordingly, each wireless device unassociated with frame 405 that wishes to transmit over the channel may wait until the channel has been clear of traffic for a DIFS duration before attempting channel access. For example, an AP 105 may wait a DIFS duration 430-a after frame 405 before transmitting forward link frame 410 to a STA 110. After reception of the forward link frame 410, the STA 110 may wait a SIFS duration 435 before sending an ACK frame 415 to the AP 105. After the end of ACK frame 415, the channel maybe clear of traffic for a DIFS duration 430-b before a wireless device unassociated with the ACK frame may be permitted to contend for the channel.

In some cases, a wireless device may attempt to access the channel during ACK frame 415 and experience a collision. In such an instance, the wireless device may delay transmission until a backoff duration has expired. The backoff duration may start after the channel has been clear for the DIFS duration 430-b, and may be a random value between 0 and the CW. The contention window is a period of time the channel is idle after a DIFS duration. CW may be set to a number between CWmin and CWmax, based at least in part on the number of times the wireless device has experienced a collision during an access attempt.

In certain cases, a wireless device may experience delay in reverse link throughput. That is, the wireless device may fail to gain access to the channel to transmit data. In such an instance, the wireless device may dynamically adjust EDCA parameters such as the CW. For example, the wireless device may reduce CWmin from unadjusted CWmin duration 420 to adjusted CWmin duration 425. Thus, the wireless device may wait a shorter duration of time after a DIFS duration to transmit. In some cases, a wireless device increases CWmin so that another wireless device has a greater likelihood of gaining access to the channel. In certain examples, a wireless device adjusts CWmax (e.g., the wireless station may increase or decrease CWmax).

In some aspects, a wireless device transmits a number of consecutive frames over the channel. In between each frame, the wireless device may wait an AIFS duration. That is, the wireless device may transmit a frame, wait an AISF duration, and then send another frame. The AIFS duration may be dynamically modified. For example, the wireless device may adjust the AIFSN to increase or decrease the AIFS duration. The wireless device may adjust the AIFSN based at least in part on a detected condition indicative of reverse link delay. For example, a wireless device experiencing reverse link delay may decrease AIFSN, thereby reducing the amount of time the wireless device waits to transmit consecutive frames. In this or other examples, the AIFSN of a wireless device unassociated with the reverse link delay may be adjusted. The adjustment of the AIFSN may be autonomously implemented or based at least in part on a request from an external entity (e.g., another wireless device, such as an AP 105).

In some cases, the wireless device transmits a number of consecutive frames without relinquishing control of the medium (e.g., via SIFS bursting). SIFS bursting parameters may be modified by the wireless device if reverse link delays are detected. For example, the wireless device (e.g., a STA 110) may detect an accumulation of queued ACKs and increase the duration of SIFS bursting. In another example, a wireless device (e.g., an AP 105) may detect a delay in reverse link data (e.g., by noticing missing ACKs) and cease or refrain from SIFS bursting. The adjustment of SIFS bursting parameters may be performed by the same wireless device that detects the reverse link delay, or by a different wireless device. That is, SIFS bursting parameter adjustments may be independently implemented by a wireless device or directed by another wireless device.

A wireless device may iteratively and adaptively adjust EDCA parameters such as the CW. For example, a wireless device may detect a delay in reverse link throughput and incrementally modify EDCA parameters until the delay has been resolved. Once the delay is no longer an issue, the EDCA parameters may be reset. In one example, the wireless device may detect a delay in an ACK transmission and continue to adjust EDCA parameters until the ACK has been transmitted. For instance, an AP 105 may adaptively adjust EDCA parameters based at least in part on the status of an ACK transmission. If the AP 105 does not receive an ACK after one adjustment, the AP 105 may make an additional adjustment. The AP 105 may adjust its own EDCA parameters or the EDCA parameters of one or more STAs 110. In some cases, the EDCA parameters which have been adjusted are reset to their original values once the wireless device experiencing the delay has reduced the delay to an acceptable threshold. The threshold may be determined by the wireless device experiencing the reverse link delay or a wireless device affected by the reverse link delay. In other cases, the EDCA parameters may be reset after the wireless device experiencing the reverse link delay has transmitted data retarded by the delay.

A wireless device may make adaptive adjustments to different EDCA parameters. The adjustments may be of varying degrees (e.g., the amount an EDCA parameter value is adjusted may be increased with the each subsequent adjustment). In some cases, EDCA parameters for multiple wireless device are adjusted. A wireless device may cease adjusting EDCA parameters upon resolution of the reverse link delay, or upon satisfaction of a EDCA parameter threshold. For example the wireless device may have value restriction corresponding to each EDCA parameter that may not be exceeded.

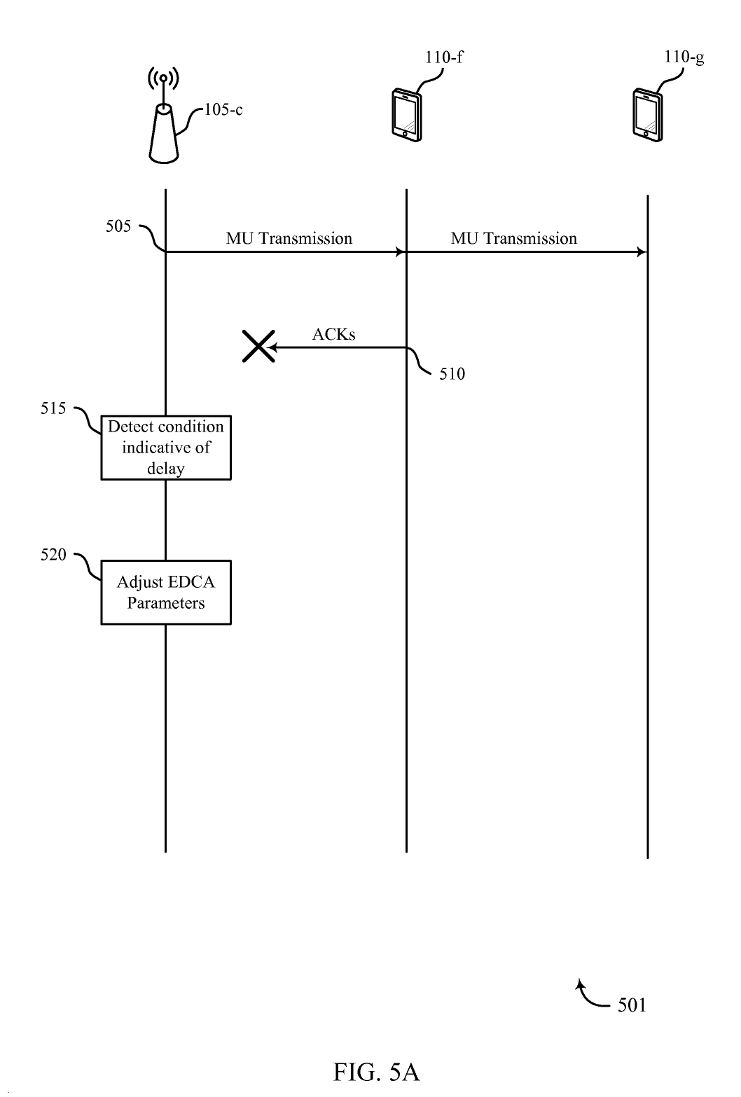

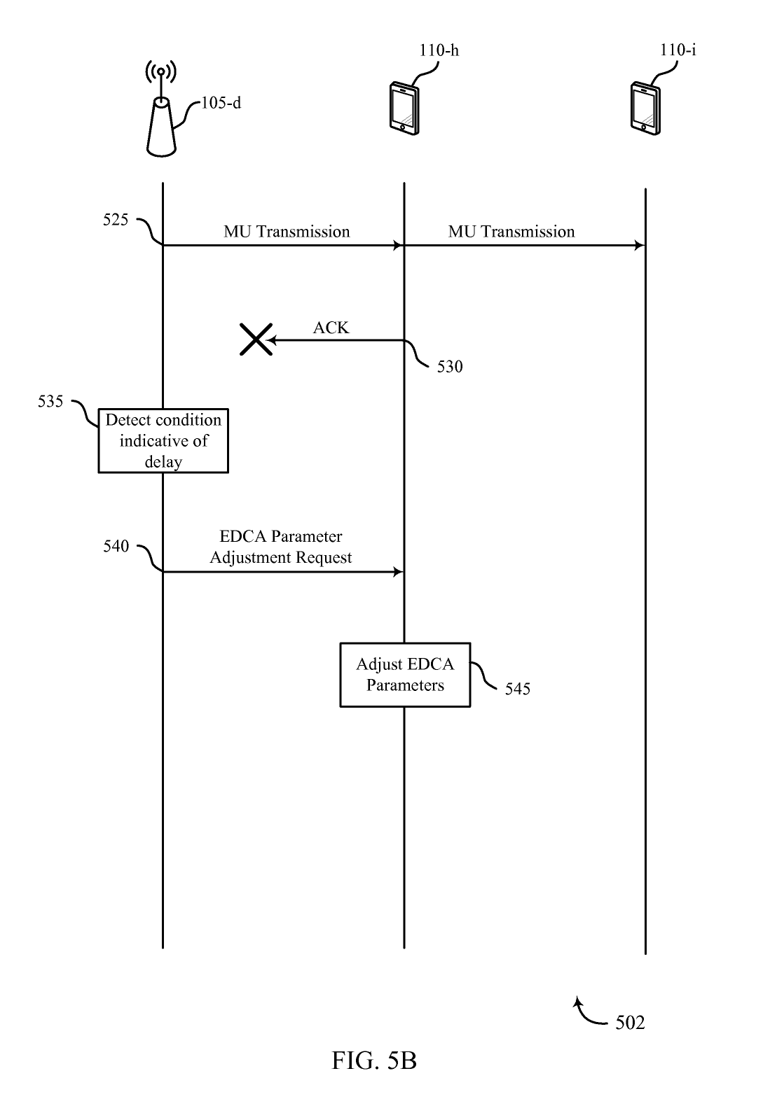

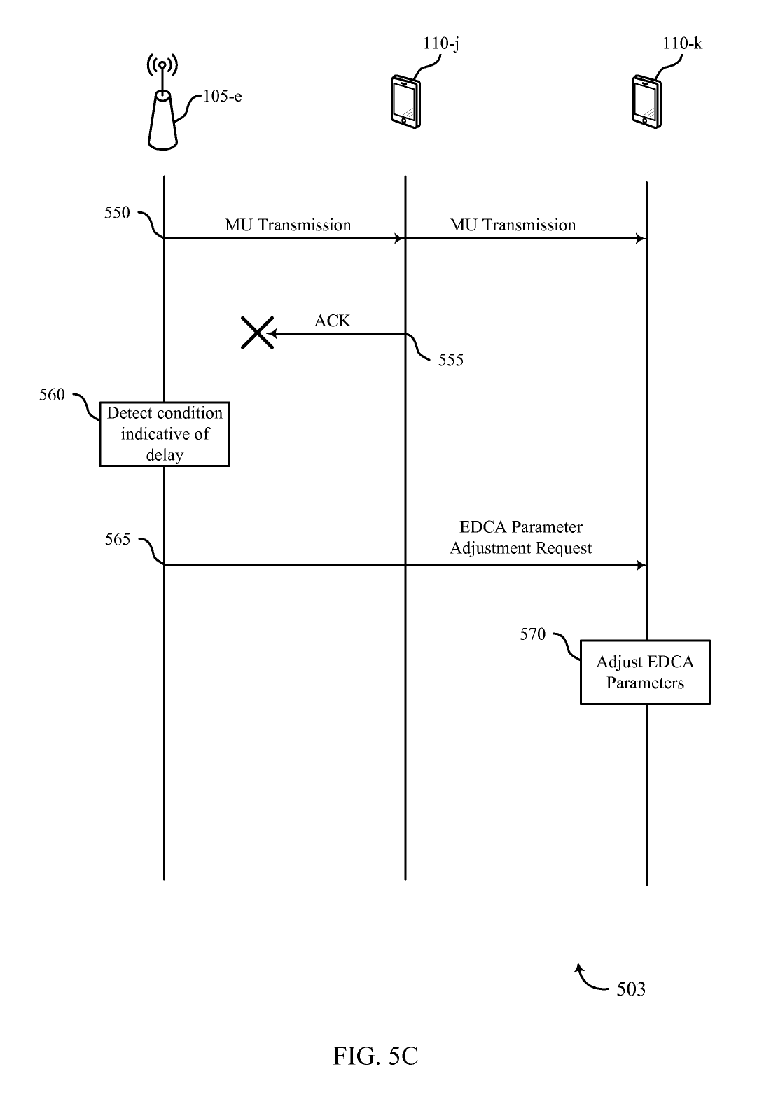

FIG. 5A illustrates a process flow 501 that supports adjustment of medium access parameters based at least in part on reverse link delay in accordance with various aspects of the present disclosure. Process flow 501 may include AP 105-c, STA 110-f, and STA 110-g, each of which may implement the features of a wireless device described herein and with respect to FIGS. 1-4. Each wireless device may be capable of supporting MU-MIMO transmissions, detecting delays in reverse link data, and adjusting channel access parameters.

At 505, AP 105-c may send, and STAs 110-f, 110-g may receive, an MU-2 transmission. Based at least in part on the reception status of the MU-2 transmission, each STA 110 may generate ACKs for the MU-2 transmission to send to AP 105-c.

At 510, STA 110-f may fail to transmit ACKs to AP 105-c. In some cases, the failure to transmit the ACKs may be due to reverse link delay. For example, STA 110-f may contend for the channel after STA 110-g has already won the channel. Thus, STA 110-f may not have an opportunity to transmit reverse link data, including ACKs associated with the MU-2 transmission. That is, STA 110-f may experience a delay in reverse link transmissions due to limited channel access.

At 515, AP 105-c may detect a condition indicative of delay, or lag, in reverse link data. In other words, AP 105-c may detect a condition indicative of a delay in reverse link throughput with respect to forward link throughput associated with a first wireless device. In one example, AP 105-c may expect to receive an ACK from STA 110-f corresponding to the MU-2 transmission. Accordingly, AP 105-c may monitor ACKs from each client STA 110 to determine if STA 110-f has transmitted any ACKs corresponding to the MU-2 transmission. If AP 105-c does not receive ACKs from STA 110-f after a certain duration of time, AP 105-c may conclude that STA 110-f is experiencing reverse link delay. Thus, detecting the condition indicative of delay may include detecting a delay in an ACK message from STA 110-f. In another aspect, AP 105-c may monitor a client transmission queue for STA 110-f. If the client queue does not have sufficient data pending for STA 110-f, AP 105-c may decide there is a delay in reverse link transmissions for STA 110-f. In some examples, detecting the condition includes monitoring the size of the client transmission queue associated with STA 110-f. Thus, AP 105-c may detect reverse link delay based at least in part on detecting insufficient data at MAC for STA 110-f.

At 520, AP 105-c may adjust an EDCA parameter. The adjustment may be based at least in part on the detected condition indicative of delay in reverse link throughput. In some examples, adjusting the EDCA parameter includes adjusting a contention window parameter for AP 105-c. Adjusting the contention window parameter may include adjusting a maximum contention window size (i.e., CWmax) for AP 105-c or adjusting a minimum contention window size (i.e., CWmin) for AP 105-c. For example, AP 105-c may increase minimum contention window size so that contention is delayed for AP 105-c. In certain aspects, adjusting the EDCA parameter may include adjusting an arbitration interframe spacing (AIFS) parameter for AP 105-c. The AIFS may indicate a period of time between a first transmission and a second transmission by AP 105-c. Adjusting the AIFS parameter may include adjusting an AIFSN assigned to AP 105-c.

FIG. 5B illustrates a process flow 502 that supports adjustment of medium access parameters based at least in part on reverse link delay in accordance with various aspects of the present disclosure. Process flow 502 may include AP 105-d, STA 110-h, and STA 110-i, each of which may implement the features of a wireless device described herein and with respect to FIGS. 1-5A.

At 525, AP 105-d may send an MU-2 transmission to STA 110-h and STA 110-i. At 530, STA 110-h may fail to transmit ACKs to AP 105-d due to reverse link delay. At 535, AP 105-d may detect a condition indicative of delay in reverse link throughput. The detection may include any of the techniques described with reference to FIGS. 3 and 5A.

At 540, AP 105-d may send, and STA 110-h may receive, an EDCA parameter adjustment request. The EDCA parameter adjustment request may indicate one or more EDCA parameter adjustments to STA 110-h. The EDCA parameter adjustment request may indicate which EDCA parameter (e.g., AIFSN) to adjust. In certain aspects, the EDCA parameter adjustment request may not indicate which EDCA parameter to adjust. For example, the EDCA parameter adjustment may indicate that the STA 110-h may adjust EDCA parameters (e.g., use more aggressive EDCA parameters) without indicating which EDCA parameters to adjust. In such an instance, STA 110-h may autonomously determine which EDCA parameters to modify. If the EDCA parameter adjustment request indicates which EDCA parameter to adjust, the EDCA parameter adjustment request may also include the extent of the adjustment. For example, the EDCA parameter adjustment request may indicate a specific CWmin adjustment by assigning a new CWmin to STA 110-h. Alternatively, the EDCA parameter adjustment may indicate a change in an EDCA parameter (e.g., the EDCA parameter adjustment may indicate that CWmin is to be decreased by a number of time slots). In certain instances, the EDCA parameter adjustment may not indicate the extent of the adjustment. In such a scenario, STA 110-h may autonomously determine the extent of the adjustment. Examples of EDCA parameter adjustments are described with reference to FIG. 5A.

FIG. 5C illustrates a process flow 503 that supports adjustment of medium access parameters based at least in part on reverse link delay in accordance with various aspects of the present disclosure. Process flow 503 may include AP 105-e, STA 110-j, and STA 110-k, each of which may implement the features of a wireless device described herein and with respect to FIGS. 1-5B.

At 550, AP 105-e may send an MU-2 transmission to STA 110-j and STA 110-k. At 555, STA 110-j may fail to transmit ACKs to AP 105-e due to reverse link delay. At 560, AP 105-e may detect a condition indicative of delay in reverse link throughput. The detection may include any of the techniques described with reference to FIGS. 3 and 5A.

At 565, AP 105-e may send an EDCA parameter adjustment request to STA 110-k. In some cases, the EDCA parameter adjustment is a unicast message directed to STA 110-k. The EDCA parameters adjustment request may indicate that STA 110-k may modify EDCA parameters, such as described with reference to FIGS. 1-4. In certain scenarios, the EDCA parameter adjustment request may assign an EDCA parameter for STA 110-k a new value. In some aspects, the EDCA parameter adjustment is a broadcast (or multicast) message intended for more than one STA 110. The EDCA parameter adjustment may include different EDCA parameter adjustments for different STAs 110.

Although described in the context of a MU-2 communications, the techniques described with respect to FIGS. 5A-5C may be implemented for other types of communications, including MU-N communications and SU communications.

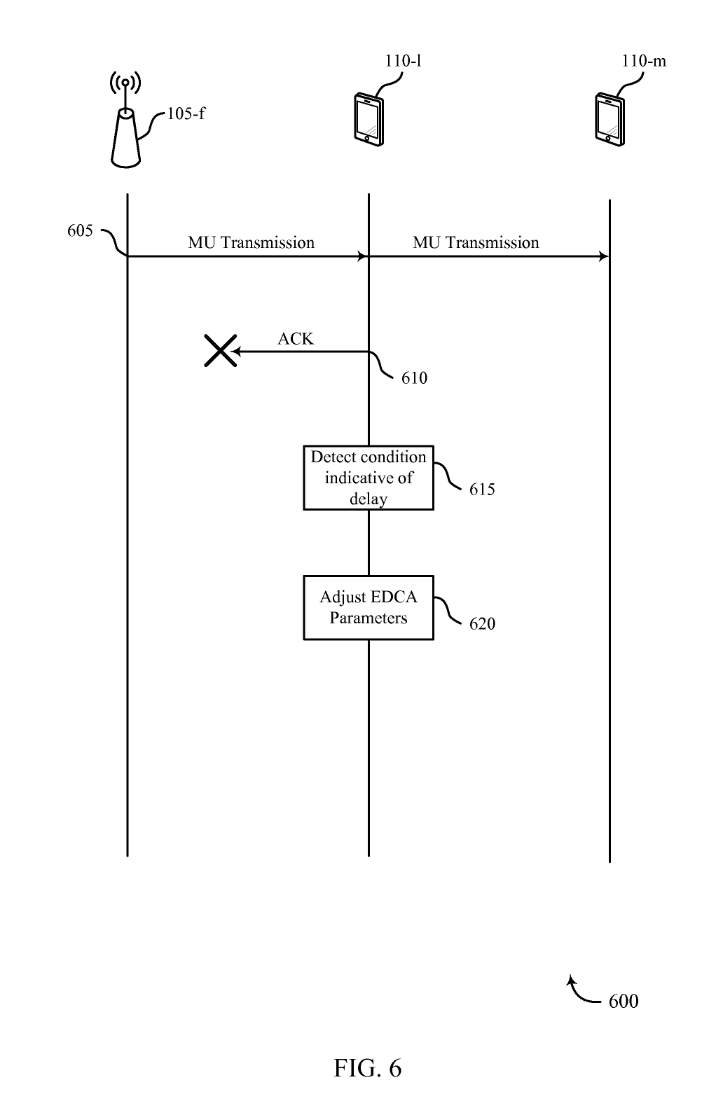

FIG. 6 illustrates an example of a process flow 600 that supports adjustment of medium access parameters based at least in part on reverse link delay in accordance with various aspects of the present disclosure. Process flow 600 may include AP 105-f, STA 110-1, and STA 110-m, which may be examples of a wireless device described with reference to FIGS. 1-5C.

At 605, AP 105-f may send an MU-2 transmission to STA 110-1 and STA 110-m. At 610, STA 110-1 may fail to transmit ACKs to AP 105-f due to reverse link delay. At 615, STA 110-1 may detect a condition indicative of delay in reverse link throughput. In some examples, detecting the condition includes processing an EDCA parameter adjustment request from AP 105-f. In some examples, detecting the condition includes exchanging a multi-user transmission. In certain aspects, adjusting the EDCA parameter is based at least in part on the size of a transmission queue of STA 110-1. For example, STA 110-1 may detect a large number of pending ACKs intended for AP 105-f.

At 620, STA 110-1 may autonomously adjust one or more EDCA parameters. The EDCA parameter adjustment may be based at least in part on detecting a condition indicative of reverse link delay. For example, a multi-user transmission duration that satisfies a threshold may trigger adjusting the EDCA parameters. The EDCA parameters may be adjusted according to any of the techniques described herein and with reference to FIGS. 1-4.

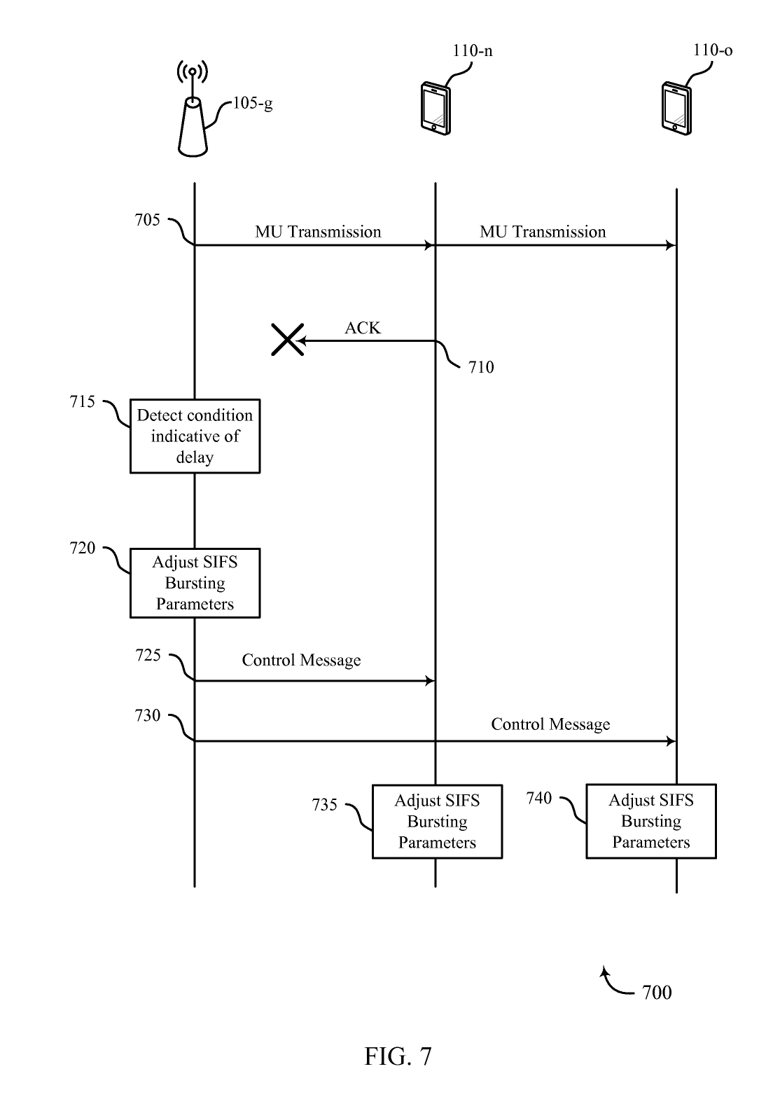

FIG. 7 illustrates an example of a process flow 700 that supports adjustment of medium access parameters based at least in part on reverse link delay in accordance with various aspects of the present disclosure. Process flow 700 may include AP 105-g, STA 110-n, and STA 110-o, each of which may be an example of a wireless device described with reference to FIGS. 1-6.

At 705, AP 105-g may send an MU-2 transmission to STA 110-n and STA 110-o. At 710, STA 110-n may fail to transmit ACKs to AP 105-g due to reverse link delay. At 715, AP 105-g may detect a condition indicative of delay in reverse link throughput. The detection may include any of the techniques described with reference to FIGS. 3 and 5A.

At 720, AP 105-g may adjust SIFS bursting parameters. For example, AP 105-g may cease or refrain from SIFS bursting. At 725, AP 105-g may send a control message to STA 110-n. The control message may indicate that STA 110-n may modify SIFS bursting parameters. At 730, AP 105-g may send a control message to STA 110-o. The control message may indicate that STA 110-o may modify SIFS bursting parameters. A control message may indicate which channel access parameters to adjust (e.g., SIFS bursting parameters). A control message may also indicate the extent of the adjustment. For example, the control message may indicate a specific modification to the SIFS bursting duration. A control message may have information intended for a single STA 110 or multiple STAs 110. Accordingly, a control message may be unicast, multicast, or broadcast.

At 735, STA 110-n may adjust SIFS bursting parameters. For example, STA 110-n may increase the duration of a SIFS bursting. STA 110-n may adjust SIFS bursting parameters based at least in part on information included in the control message from AP 105-g. At 740, STA 110-o may adjust SIFS bursting parameters. STA 110-o may adjust SIFS bursting parameters based at least in part on information included in the control message from AP 105-g.

In some aspects, STA 110-n or STA 110-o may autonomously detect a condition indicative of reverse link delay. The detection may include techniques described with reference to FIGS. 3 and 6. Based at least in part on the detected condition, STA 110-n or STA 110-o may independently adjust SIFS bursting parameters.

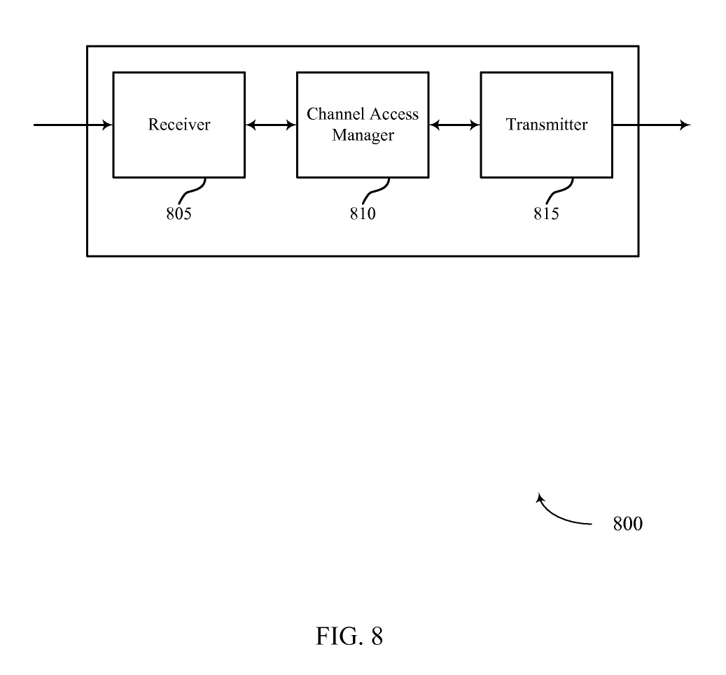

FIG. 8 shows a block diagram of a wireless device 800 configured for adjustment of medium access parameters based at least in part on reverse link delay in accordance with various aspects of the present disclosure. Wireless device 800 may be an example of aspects of a wireless device described with reference to FIGS. 1-7. Wireless device 800 may include a receiver 805, a channel access manager 810, or a transmitter 815. Wireless device 800 may also include a processor. Each of these components may be in communication with each other.

The receiver 805 may receive information such as packets, user data, or control information associated with various information channels (e.g., control channels, data channels, and information related to adjustment of medium access parameters based at least in part on reverse link delay, etc.). Information may be passed on to the channel access manager 810, and to other components of wireless device 800. The channel access manager 810 may detect a condition indicative of a delay in reverse link throughput with respect to forward link throughput associated with a first wireless device. The channel access manager 810 may adjust, based at least in part on the detected condition, an EDCA parameter associated with one or more wireless devices. The transmitter 815 may transmit signals received from other components of wireless device 800. In some examples, the transmitter 815 may be collocated with the receiver 805 in a transceiver module. The transmitter 815 may include a single antenna, or it may include a plurality of antennas.

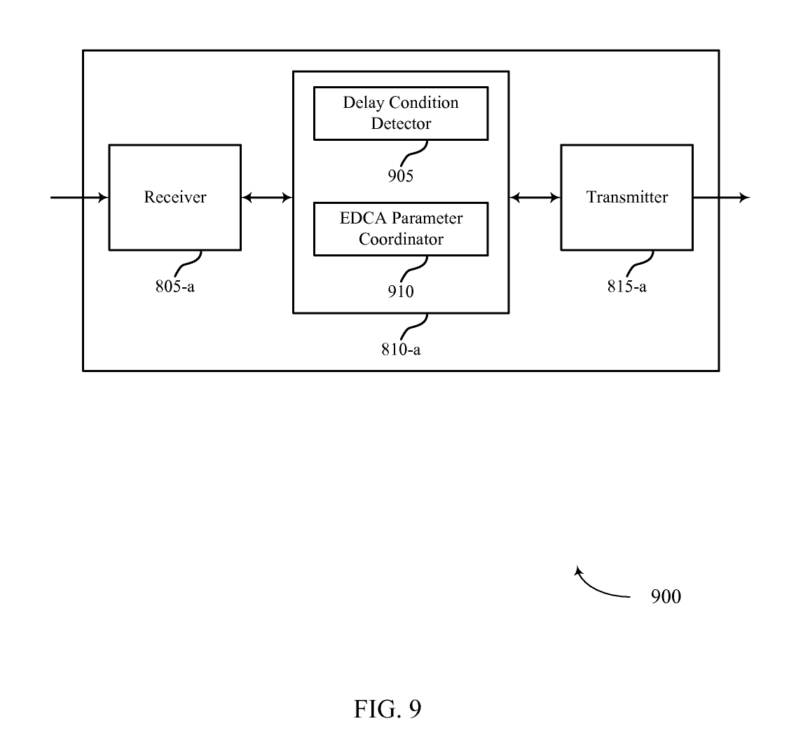

FIG. 9 shows a block diagram of a wireless device 900 for adjustment of medium access parameters based at least in part on reverse link delay in accordance with various aspects of the present disclosure. Wireless device 900 may be an example of aspects of a wireless device 800 or a wireless device described with reference to FIGS. 1-8. Wireless device 900 may include a receiver 805-a, a channel access manager 810-a, or a transmitter 815-a. Wireless device 900 may also include a processor. Each of these components may be in communication with each other. Alternative or additional to FIG. 8, the channel access manager 810-a may include a delay condition detector 905 and an EDCA parameter coordinator 910.

The receiver 805-a may receive information which may be passed on to channel access manager 810-a, and to other components of wireless device 900. The channel access manager 810-a may perform the operations described with reference to FIG. 8. The transmitter 815-a may transmit signals received from other components of wireless device 900. The delay condition detector 905 may detect a condition indicative of a delay in reverse link throughput with respect to forward link throughput associated with a first wireless device as described with reference to FIGS. 2-7. The EDCA parameter coordinator 910 may adjust, based at least in part on the detected condition, an enhanced distribution channel access (EDCA) parameter associated with one or more wireless devices as described with reference to FIGS. 2-7.

The components of wireless device 800, wireless device 900, and channel access manager 810 may, individually or collectively, be implemented with at least one application specific integrated circuit (ASIC) adapted to implement some or all of the applicable features in hardware. Alternatively, the features may be implemented by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The features of each unit may also be implemented, in whole or in part, with instructions embodied in a memory, formatted to be executed by one or more general or application-specific processors.

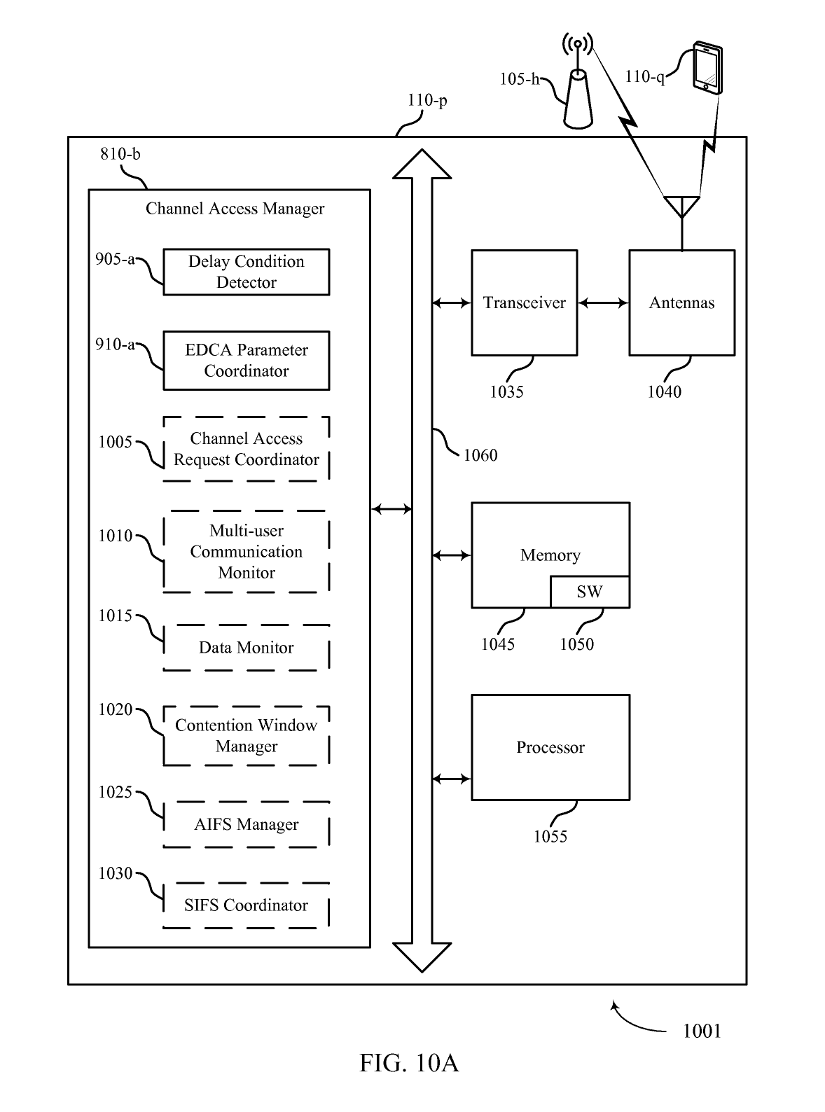

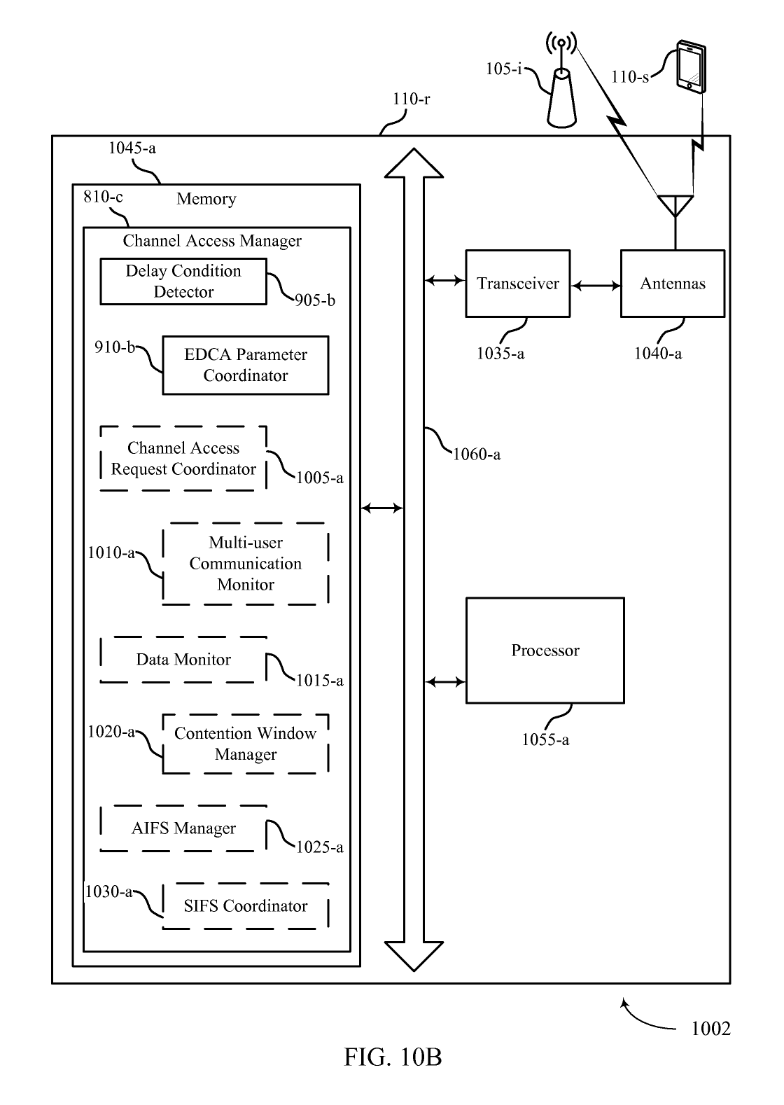

FIG. 10A a diagram of a system 1001 including STA 110-p configured for adjustment of medium access parameters based at least in part on reverse link delay in accordance with various aspects of the present disclosure. STA 110-p may be an example of a wireless device describe herein, and with reference to FIGS. 1-9. STA 110-p may include a channel access manager 810-b, which may be an example of a channel access manager 810 or 810-a described with reference to FIGS. 8 and 9. STA 110-p may also include components for bi-directional voice and data communications including components for transmitting communications and components for receiving communications. For example, STA 110-p may communicate bi-directionally with AP 105-h or STA 110-q. The transceiver 1035 may communicate bi-directionally, via the antennas 1040 or wired or wireless links, with one or more networks, as described above. For example, the transceiver 1035 may communicate bi-directionally with AP 105-h by receiving an MU-N transmission and transmitting a corresponding ACK. The transceiver 1035 may include a modem to modulate the packets and provide the modulated packets to the antennas 1040 for transmission, and to demodulate packets received from the antennas 1040. While STA 110-p may include a single antenna 1040, STA 110-p may also have multiple antennas 1040 capable of concurrently transmitting or receiving multiple wireless transmissions (e.g., MU-N transmissions).

The components of the channel access manager 810-b may, individually or collectively, be implemented with at least one ASIC adapted to implement some or all of the applicable features in hardware. Alternatively, the features may be implemented by one or more other processing units (or cores), on at least one IC. In other examples, other types of integrated circuits may be used (e.g., Structured/Platform ASICs, an FPGA, or another semi-custom IC), which may be programmed in any manner known in the art. The features of each unit may also be implemented, in whole or in part, with instructions embodied in a memory, formatted to be executed by one or more general or application-specific processors.

STA 110-p may be capable of receiving MU-N transmissions from an AP 105 (i.e., AP 105-h). STA 110-p may transmit data, such as ACKs, to other wireless devices. STA 110-p may access a shared channel to transmit data according to EDCA protocol. Thus, STA 110-p may be assigned certain EDCA parameters, such as CWmin, CWmax, and AIFSN. In certain cases, STA 110-p may update, or modify, the assigned EDCA parameters. The adjustments may be performed autonomously or according to a request from an external entity (e.g., AP 105-h). The adjustments may be based at least in part on a delay in reverse link throughput, which may be detected by STA 110-p (or AP 105-h) according to the various techniques disclosed herein. STA 110-p may perform such techniques, methods, and processes via the channel access manager 810-b. The channel access manager 810-b may include a delay condition detector 905-a and an EDCA parameter coordinator 910-a. Each of these modules may perform the features described with reference to FIG. 9. The channel access manager 810-b may also include a channel access request coordinator 1005, a multi-user communication monitor 1010, a data monitor 1015, a contention window manager 1020, an AIFS manager 1025, and a SIFS coordinator 1030.

The channel access request coordinator 1005 may be configured to process EDCA parameter adjustment requests. For example, the channel access request coordinator may receive, via communications with the transceiver 1035, an EDCA parameter adjustment request (e.g., from an AP 105) indicating that STA 110-p may modify one or more EDCA parameters. The EDCA parameter adjustment request may indicate which EDCA parameter to adjust, and the amount of the adjustment. The EDCA parameter adjustment request may assign a value to an EDCA parameter of STA 110-p. The channel access request coordinator may process the EDCA parameter request and pass the information to other components of STA 110-p. In some instances, the EDCA parameter adjustment request may indicate a delay in reverse link throughput. Thus, as described with reference to FIGS. 2-7, STA 110-p may detect a condition indicative of reverse link delay by processing an EDCA parameter adjustment request using channel access request coordinator 1005.

The multi-user communication monitor 1010 may be configured to detect reverse link delay by monitoring MU-N transmissions. For instance, the multi-user communication monitor 1010 may detect, via communication with the transceiver 1035, an MU-N transmission from an AP 105 and determine that reverse link delay is likely. In some cases, the multi-user communication monitor 1010 may trigger EDCA parameter adjustments based at least in part on the duration of an MU-N transmission. Thus, as described with reference to FIGS. 2-7, STA 110-p may detect a condition indicative of reverse link delay by using multi-user communication monitor 1010 to monitor MU-N communication exchanges.

The data monitor 1015 may be configured to detect a condition indicative of reverse link delay by monitoring data pending in buffer queues. For example, data monitor 1015 may monitor the amount of ACKs in a queue and determine that reverse link throughput is delayed based at least in part on the number of pending ACKs. Thus, as described with reference to FIGS. 2-7, STA 110-p may detect a condition indicative of reverse link delay by using data monitor 1015 to monitor queued data. The contention window manager 1020 may be configured to adjust a contention window parameter for STA 110-p as described with reference to FIGS. 2-7. In some examples, adjusting the contention window parameter includes adjusting a maximum contention window size (CWmax) for the wireless device. In some examples, adjusting the contention window parameter includes adjusting a minimum contention window size (CWmin) for the wireless device.

The AIFS manager 1025 may be configured to adjust an AIFS parameter for STA 110-p. The AIFS may indicate a period of time between a first transmission and a second transmission by STA 110-p. AIFS manager 1025 may modify AIFS parameters by adjusting an AIFSN for STA 110-p. Thus, as described with reference to FIGS. 2-7, STA 110-p may adjust AIFS parameters via AIFS manager 1025. The SIFS coordinator 1030 may be configured to modify a SIFS bursting parameter associated with STA 110-p as described with reference to FIGS. 2-7. In some cases, the SIFS coordinator 1030 may adjust a SIFS bursting parameter based at least in part on a detected condition indicative of delay. For example, the SIFS coordinator 1030 may increase a SIFS bursting duration.

STA 110-p may also include a processor 1055 and memory 1045 (including software (SW) 1050). The memory 1045 may include random access memory (RAM) and read only memory (ROM). The memory 1045 may store computer-readable, computer-executable software/firmware code 1050 including instructions that, when executed, cause the processor 1055 to implement various features described herein (e.g., adjustment of medium access parameters based at least in part on reverse link delay, etc.). Alternatively, the software/firmware code 1050 may not be directly executable by the processor 1055 but cause a computer (e.g., when compiled and executed) to implement features described herein. The processor 1055 may include an intelligent hardware device (e.g., a central processing unit (CPU), a microcontroller, an ASIC, etc.).

FIG. 10B shows a diagram of a system 1001 including a STA 110-r configured for adjustment of medium access parameters based at least in part on reverse link delay in accordance with various aspects of the present disclosure. STA 110-r may be an example of a wireless device or STA 110 described with reference to FIGS. 1-10A. STA 110-r may include a processor 1055-a, memory 1045-a, transceiver 1035-a, and antenna(s) 1040-a, each of which may implement the features described above with reference to FIG. 10A, and each of which may communicate, directly or indirectly, with one another (e.g., via buses 1060-a).

In the present example, the memory 1045-a may include software that implements the features of channel access manager 810-c. For example, the memory 1045-a may include software that, when compiled and executed, implements the features of delay condition detector 905-b, EDCA parameter coordinator 910-b, channel access request coordinator 1005-a, multi-user communication monitor 1010-a, data monitor 1015-a, contention window manager 1020-a, AIFS manager 1025-a, and SIFS coordinator 1030-a, such as described with reference to FIGS. 8-10A. In some cases, a subset of the features of channel access manager 810-c is included in the memory 1045-a; in other cases, all of the features may be implemented as software executed by the processor 1055-a to cause STA 110-r to implement the features of channel access manager 810-c. For example, the features of the delay condition detector 905-b and EDCA parameter coordinator 910-b may be accomplished by software included the memory 1045-a, while the features of channel access request coordinator 1005-a, multi-user communication monitor 1010-a, data monitor 1015-a, contention window manager 1020-a, AIFS manager 1025-a, and SIFS coordinator 1030-a may be accomplished using hardware. Regardless of the distribution, STA 110-r may detect delays in reverse link throughput and adjust EDCA parameters accordingly.

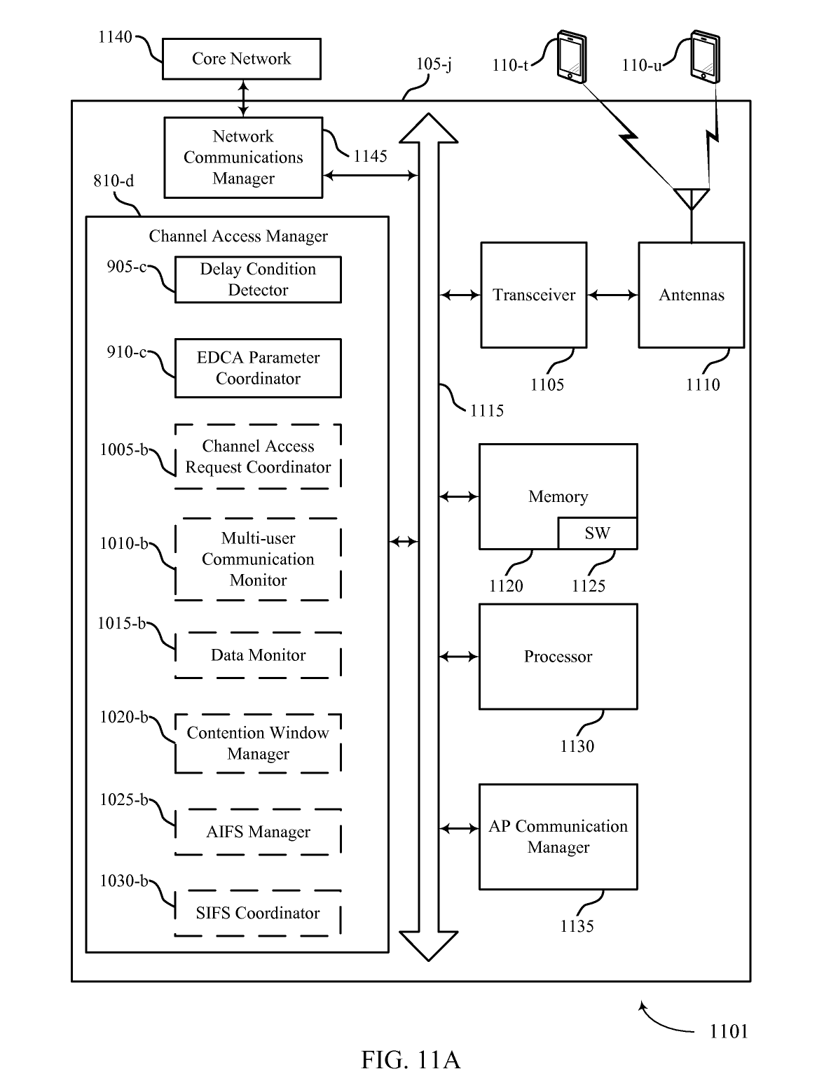

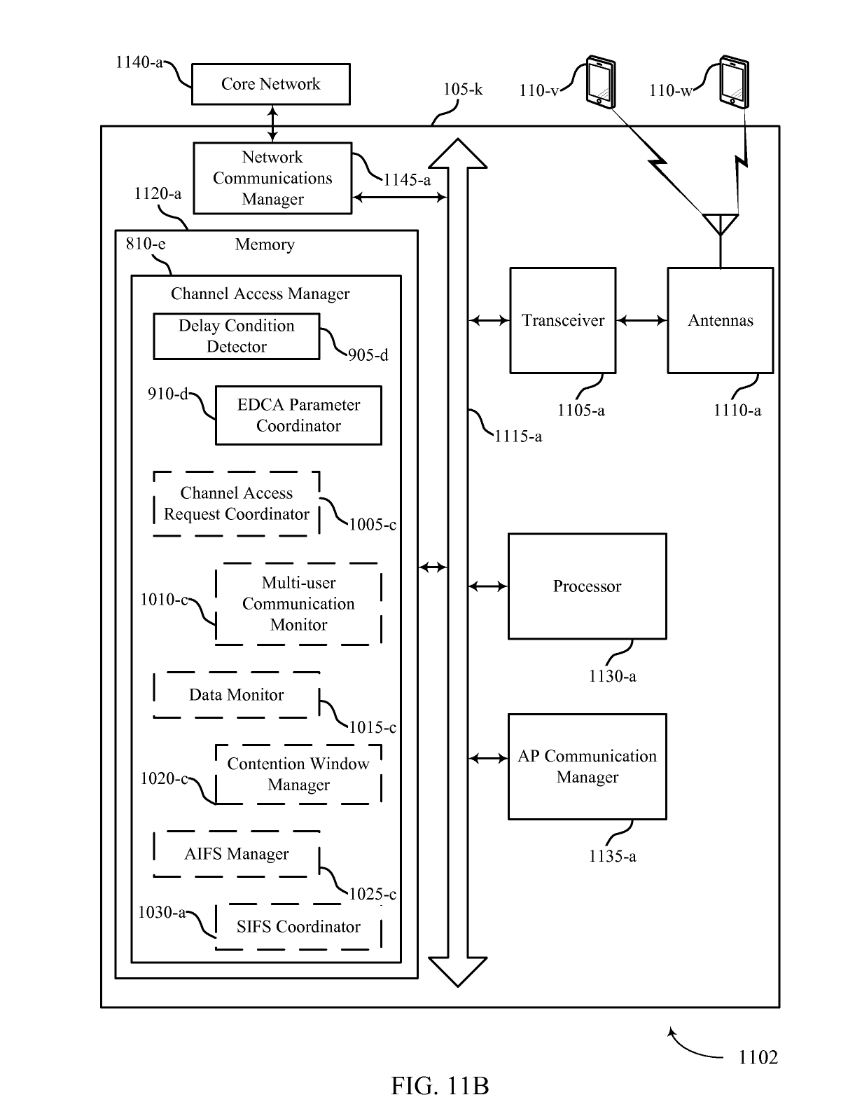

FIG. 11A shows a diagram of a system 1101 including AP 105-j configured for adjustment of medium access parameters based at least in part on reverse link delay in accordance with various aspects of the present disclosure. AP 105-j may be an example of a wireless device 800, a wireless device 900, or an AP 105 described with reference to FIGS. 1, 2, 10, and 11. AP 105-j may include a channel access manager 810-d, which may be an example of a channel access manager 810 described with reference to FIGS. 8 and 9. AP 105-j may also include components for bi-directional voice and data communications including components for transmitting communications and components for receiving communications. For example, AP 105-j may communicate bi-directionally with STA 110-t or STA 110-u (e.g., via MU-N tranmissions). The transceiver 1105 may be configured to communicate bi-directionally, via the antenna(s) 1110, with the STA 110-t and STA-u, which may be multi-mode devices. The transceiver 1105 (or other components of AP 105-j) may also be configured to communicate bi-directionally, via the antennas 1110, with one or more other APs (not shown). The transceiver 1105 may include a modem configured to modulate the packets and provide the modulated packets to the antennas 1110 for transmission, and to demodulate packets received from the antennas 1110. The AP 105-j may include multiple transceivers 1105, each with one or more associated antennas 1110. The transceiver may be an example of a combined receiver 805 and transmitter 815 of FIG. 8. In some cases, AP 105-j may communicate with other APs utilizing AP communication manager 1135. In some cases, AP 105-j may communicate with the core network 1140 through network communications manager 1145.

The channel access manager 810-d may include a delay condition detector 905-c and an EDCA parameter coordinator 910-c. Each of these modules may implement the features described with reference to FIG. 9. The channel access manager 810-d may also include a channel access request coordinator 1005-b, a multi-user communication monitor 1010-b, a data monitor 1015-b, a contention window manager 1020-b, an AIFS manager 1025-b, and a SIFS coordinator 1030-b.

The channel access request coordinator 1005-b may be configured to process EDCA parameter adjustment requests. For example, the channel access request coordinator 1005-b may generate an EDCA parameter adjustment request for STA 110-t indicating that STA 110-t may modify one or more EDCA parameters. The EDCA parameter adjustment request may indicate which EDCA parameter to adjust, and the amount of the adjustment. In some cases, the EDCA parameter adjustment request may assign a new value to an EDCA parameter for STA 110-t. The channel access request coordinator 1005-b may generate the EDCA parameter request based at least in part on information passed from other components of AP 105-j. In some instances, the EDCA parameter adjustment request may indicate a delay in reverse link throughput.

The multi-user communication monitor 1010-b may be configured to detect reverse link delay by monitoring MU-N transmissions. For instance, the multi-user communication monitor 1010 may detect an MU-N transmission has occurred and determine that reverse link delay is likely. In some cases, the multi-user communication monitor 1010-b may trigger EDCA parameter adjustments based at least in part on the duration of an MU-N transmission. Thus, as described with reference to FIGS. 2-7, AP 105-j may detect a condition indicative of reverse link delay by using multi-user communication monitor 1010-b to monitor MU-N transmissions.

The data monitor 1015-b may be configured to detect a condition indicative of reverse link delay by monitoring data pending in buffer queues. For example, data monitor 1015-b may monitor the amount of data available for STA 110-t and determine that reverse link throughput is delayed based at least in part on the amount of available data. In some cases, data monitor 1015-b may monitor ACKs for STA 110-t and determine that STA 110-t is experiencing reverse link delay based at least in part on un-received expected ACKs. Thus, as described with reference to FIGS. 2-7, AP 105-j may detect a condition indicative of reverse link delay by using data monitor 1015-b to monitor queued and received data. The contention window manager 1020-b may be configured to adjust a contention window parameter for AP 105-j as described with reference to FIGS. 2-7. In some examples, adjusting the contention window parameter includes adjusting a maximum contention window size (CWmax) for the wireless device. In some examples, adjusting the contention window parameter includes adjusting a minimum contention window size (CWmin) for the wireless device.

The AIFS manager 1025-b may be configured to adjust an arbitration interframe spacing (AIFS) parameter. The AIFS may indicate a period of time between a first transmission and a second transmission by AP 105-j, or a STA 110. The AIFS parameter may include an arbitration interframe space number (AIFSN). The AIFS manager 1025-b may adjust an AIFS parameter by adjusting the AIFSN for AP 105-j. In some cases, the AIFS manager 1025-b may adjust an AIFS parameter for a STA 110. The SIFS coordinator 1030-b may be configured to modify a short interframe space (SIFS) bursting parameter, as described with reference to FIGS. 2-7. In some cases, the SIFS coordinator 1030-b may adjust a SIFS bursting parameter based at least in part on a detected condition indicative of delay. For example, the SIFS coordinator 1030-b may increase a SIFS bursting duration for a STA 110. In another example, the SIFS coordinator 1030-b may stop SIFS bursting for AP 105-j.

The AP 105-j may include a processor 1130 and memory 1120 (including software (SW) 1125). The memory 1120 may include RAM and ROM. The memory 1120 may also store computer-readable, computer-executable software code 1125 containing instructions that are configured to, when executed, cause the processor 1130 to implement various features described herein (e.g., adjustment of medium access parameters based at least in part on reverse link delay, etc.). Alternatively, the software 1125 may not be directly executable by the processor 1130 but may be configured to cause the computer (e.g., when compiled and executed) to perform features described herein. The processor 1130 may include an intelligent hardware device (e.g., a CPU, a microcontroller, an ASIC, etc.). The processor 1130 may include various special purpose processors such as encoders, queue processing modules, base band processors, radio head controllers, digital signal processor (DSPs), and the like.

The AP communication manager 1135 may manage communications with other APs 105. In some cases, AP communication manager 1135 may include a controller or scheduler for controlling communications with STAs 110 in cooperation with other APs 105. For example, the AP communication manager 1135 may coordinate scheduling for transmissions to STAs 110 for various interference mitigation techniques such as beamforming or joint transmission.

FIG. 11B shows a diagram of a system 1102 including AP 105-k configured for adjustment of medium access parameters based at least in part on reverse link delay in accordance with various aspects of the present disclosure. AP 105-k may be an example of a wireless device 800, a wireless device 900, or an AP 105 described with reference to FIGS. 1-11A. AP 105-k may include a channel access manager 810-d, which may be an example of a channel access manager 810 described with reference to FIGS. 8 and 9. AP 105-k may include a processor 1130-a, memory 1120-a, transceiver 1105-a, AP communication manager 1135-a, network communications manager 1145-a, and antenna(s) 1110-a, each of which may implement the features described above with reference to FIG. 11A, and each of which may communicate, directly or indirectly, with one another (e.g., via bus system 1115-a).

In the present example, the memory 1120-a may include software that implements the features of channel access manager 810-e. For example, memory 1120-a may include software that, when compiled and executed, implements the features of the delay condition detector 905-d, EDCA parameter coordinator 910-d, channel access request coordinator 1005-c, multi-user communication monitor 1010-c, data monitor 1015-c, contention window manager 1020-c, AIFS manager 1025-c, and SIFS coordinator 1030-c, such as described with reference to FIGS. 8-11A. In some cases, a subset of the features of channel access manager 810-e is included in memory 1120-a; in other cases, all of the features may be implemented as software executed by the processor 1130-a to cause AP 105-k to implement the features of channel access manager 810-e. For example, the features of the delay condition detector 905-d and EDCA parameter coordinator 910-d may be accomplished by software included the memory 1120-a, while the features of channel access request coordinator 1005-c, multi-user communication monitor 1010-c, data monitor 1015-c, contention window manager 1020-c, AIFS manager 1025-c, and SIFS coordinator 1030-c may be accomplished using hardware. Regardless of the distribution, AP 105-k may detect delays in reverse link throughput and adjust EDCA parameters accordingly.

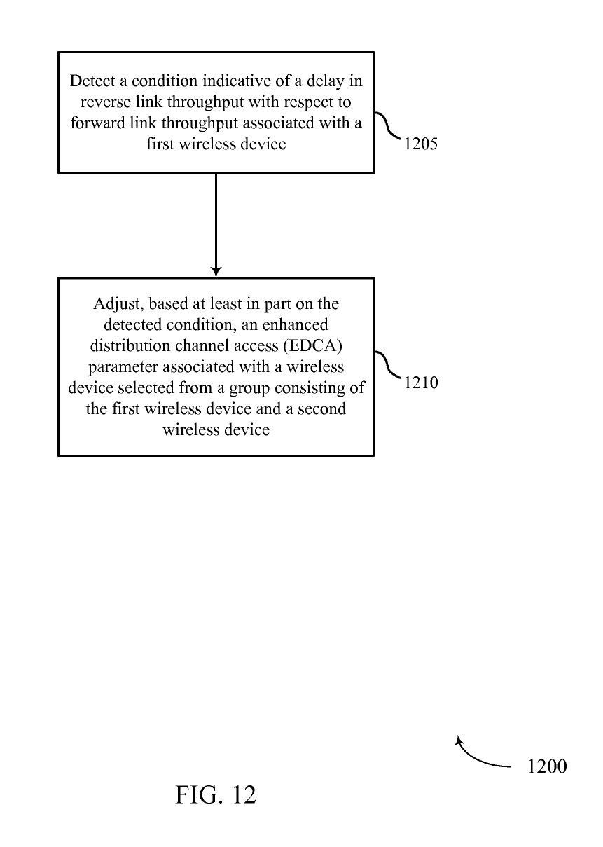

FIG. 12 shows a flowchart illustrating a method 1200 for adjustment of medium access parameters based at least in part on reverse link delay in accordance with various aspects of the present disclosure. The operations of method 1200 may be implemented by a wireless device (e.g., an AP 105 or a STA 110) or its components as described with reference to FIGS. 1-11B. For example, the operations of method 1200 may be performed by the channel access manager 810 as described with reference to FIGS. 8-11B. In some examples, a wireless device may execute a set of codes to control the wireless device to perform the features described below. Additionally or alternatively, the wireless device may implement aspects of the features described below using special-purpose hardware.

At block 1205, the wireless device detects a condition indicative of a delay in reverse link throughput with respect to forward link throughput associated with a first wireless device as described with reference to FIGS. 2-7. Detecting the condition may include exchanging a multi-user transmission. Detecting the condition may include detecting a delay in an acknowledgment message from a wireless device. In certain instances, detecting the condition may include monitoring a size of a transmission queue. In certain examples, the operations of block 1205 may be performed or facilitated by the delay condition detector 905 as described with reference to FIG. 9.

Proceeding to block 1210, the wireless device adjusts, based at least in part on the detected condition, an EDCA parameter associated with a wireless device selected from a group consisting of: the first wireless device and a second wireless device as described with reference to FIGS. 2-7. Adjusting the EDCA parameter may be triggered by a multi-user transmission exchange. In some cases, adjusting the EDCA parameter may be based at least in part on a transmission queue size. In certain scenarios, adjusting the EDCA parameter may include adjusting an AIFS parameter. The AIFS parameter may indicate a period of time between a first transmission and a second transmission of the wireless device. The AIFS parameter may include an AIFSN. Accordingly, adjusting the AIFS parameter may include modifying the AIFSN for the wireless device. In certain examples, the operations of block 1210 may be performed or facilitated by the EDCA parameter coordinator 910 as described with reference to FIG. 9.

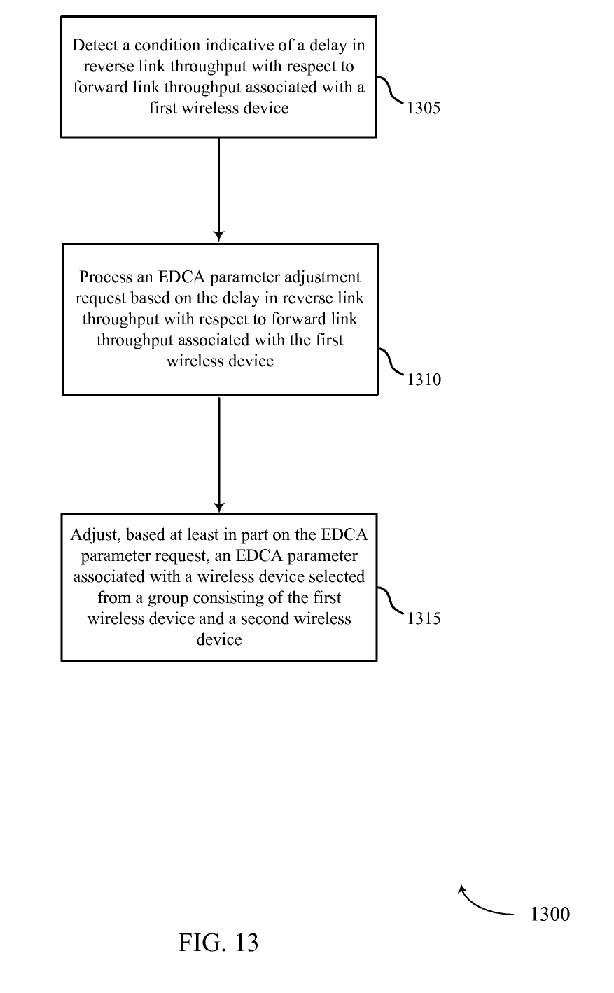

FIG. 13 shows a flowchart illustrating a method 1300 for adjustment of medium access parameters based at least in part on reverse link delay in accordance with various aspects of the present disclosure. The operations of method 1300 may be implemented by a wireless device or its components as described with reference to FIGS. 1-12. For example, the operations of method 1300 may be performed by the channel access manager 810 as described with reference to FIGS. 8-11B. In some examples, a wireless device may execute a set of codes to control the wireless device to perform the features described below. Additionally or alternatively, the wireless device may implement aspects of the features described below using special-purpose hardware. The method 1300 may incorporate aspects of method 1200 of FIG. 12.

At block 1305, the wireless device detects a condition indicative of a delay in reverse link throughput with respect to forward link throughput associated with a first wireless device as described with reference to FIGS. 2-7. In certain examples, the operations of block 1305 may be performed by the delay condition detector 905 as described with reference to FIG. 9. Proceeding to block 1310, the wireless device processes an EDCA parameter adjustment request. The EDCA parameter adjustment request may be based at least in part on the delay in reverse link throughput with respect to forward link throughput associated with the first wireless device. In certain examples, the operations of block 1310 may be performed or facilitated by the channel access request coordinator 1005 as described with reference to FIGS. 10A-11B.

Next, at block 1315, the wireless device adjusts, based at least in part on the EDCA parameter request, an EDCA parameter associated with a wireless device selected from a group consisting of: the first wireless device and a second wireless device as described with reference to FIGS. 2-7. In certain scenarios, adjusting the EDCA parameter may include providing the adjusted EDCA parameter to the wireless device and providing a second adjusted EDCA parameter to a third wireless device. The second adjusted EDCA parameter may be different from the adjusted EDCA parameter. In certain examples, the operations of block 1315 may be performed or facilitated by the EDCA parameter coordinator 910 as described with reference to FIG. 9.

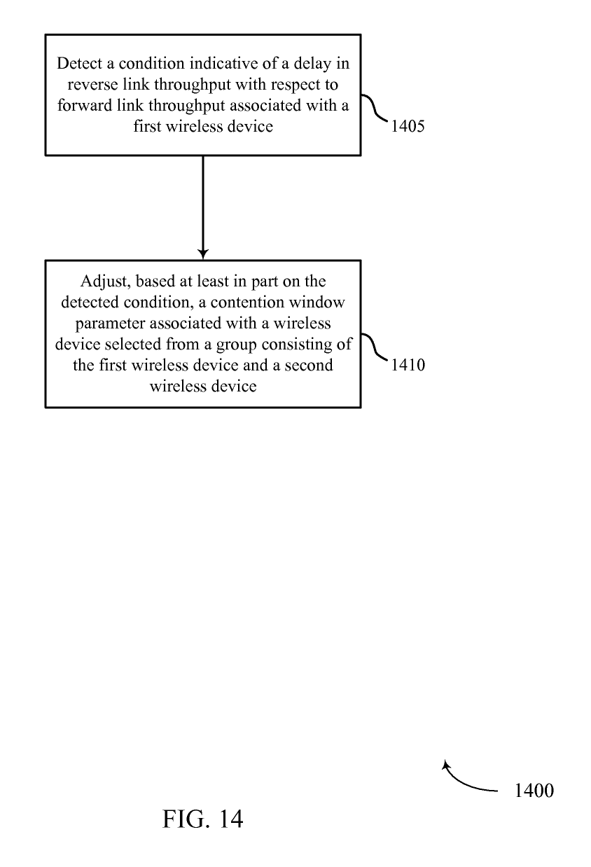

FIG. 14 shows a flowchart illustrating a method 1400 for adjustment of medium access parameters based at least in part on reverse link delay in accordance with various aspects of the present disclosure. The operations of method 1400 may be implemented by a wireless device or its components as described with reference to FIGS. 1-11B. For example, the operations of method 1400 may be performed by the channel access manager 810 as described with reference to FIGS. 8-11B. In some examples, a wireless device may execute a set of codes to control the wireless device to perform the features described below. Additionally or alternatively, the wireless device may implement aspects of the features described below using special-purpose hardware. The method 1400 may also incorporate aspects of methods 1200 and 1300 of FIGS. 12 and 13.

At block 1405, the wireless device detects a condition indicative of a delay in reverse link throughput with respect to forward link throughput associated with a first wireless device as described with reference to FIGS. 2-7. In certain examples, the operations of block 1405 may be performed by the delay condition detector 905 as described with reference to FIG. Proceeding to block 1410, the wireless device adjusts, based at least in part on the detected condition, a contention window parameter associated with a wireless device selected from a group consisting of the first wireless device and a second wireless device as described with reference to FIGS. 2-7. Adjusting the contention window parameter may include adjusting a maximum contention window size. Adjusting the contention window parameter may include adjusting a minimum contention window size. In certain examples, the operations of block 1410 may be performed or facilitated by the EDCA parameter coordinator 910 as described with reference to FIG. 9.

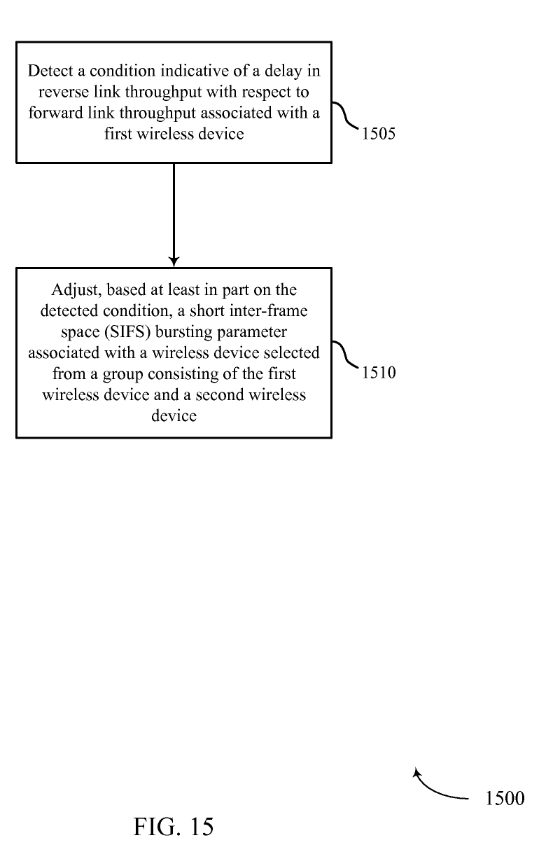

FIG. 15 shows a flowchart illustrating a method 1500 for adjustment of medium access parameters based at least in part on reverse link delay in accordance with various aspects of the present disclosure. The operations of method 1500 may be implemented by a wireless device or its components as described with reference to FIGS. 1-11B. For example, the operations of method 1500 may be performed by the channel access manager 810 as described with reference to FIGS. 8-11. In some examples, a wireless device may execute a set of codes to control the wireless device to perform the features described below. Additionally or alternatively, the wireless device may implement aspects of the features described below using special-purpose hardware. The method 1500 may also incorporate aspects of methods 1200, 1300, and 1400 of FIGS. 12-14.

At block 1505, the wireless device detects a condition indicative of a delay in reverse link throughput with respect to forward link throughput associated with a first wireless device as described with reference to FIGS. 2-7. In certain examples, the operations of block 1505 may be performed by the delay condition detector 905 as described with reference to FIG. 9. Proceeding to block 1510, the wireless device adjusts, based at least in part on the detected condition, a short interframe space (SIFS) bursting parameter associated with a wireless device selected from a group consisting of the first wireless device and a second wireless device as described with reference to FIGS. 2-7. Adjusting the SIFS bursting parameter may include increasing a SIFS bursting duration of the wireless device. Adjusting the SIFS bursting parameter may include ceasing, or refraining from, SIFS bursting for the wireless device. In certain examples, the operations of block 1510 may be performed or facilitated by the EDCA parameter coordinator 910 as described with reference to FIG. 9.

It should be noted that methods 1200, 1300, 1400, and 1500 describe possible implementations. The operations or blocks may be rearranged or otherwise modified such that other implementations are possible. In some examples, aspects from two or more of the methods 1200, 1300, 1400, and 1500 may be combined.

The description herein provides examples, and is not limiting of the scope, applicability, or examples set forth in the claims. Changes may be made in the features and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to implement the features described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The features described herein may be implemented in hardware, software executed by a processor, firmware, or any combination thereof. If implemented in software executed by a processor, the features may be stored on or transmitted over as one or more instructions or code on a computer-readable medium. Other examples and implementations are within the scope of the disclosure and appended claims. For example, due to the nature of software, features described above can be implemented using software executed by a processor, hardware, firmware, hardwiring, or combinations of any of these. Implemented features may also be physically located at various positions, including being distributed such that portions of the features are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of communication at a wireless device, comprising:
detecting a condition indicative of a delay in reverse link throughput with respect to forward link throughput associated with a first wireless device; and
adjusting, based at least in part on the detected condition, an enhanced distribution channel access (EDCA) parameter associated with a wireless device selected from a group consisting of: the first wireless device and a second wireless device.

2. The method of claim 1, wherein detecting the condition comprises:
processing an EDCA parameter adjustment request based at least in part on the delay in reverse link throughput with respect to forward link throughput associated with the first wireless device.

3. The method of claim 1, wherein detecting the condition comprises:
exchanging a multi-user transmission, wherein the multi-user transmission triggers adjusting the EDCA parameter.

4. The method of claim 1, wherein detecting the condition comprises:
monitoring a size of a transmission queue associated with the first wireless device, wherein adjusting the EDCA parameter is based at least in part on the size of the transmission queue.

5. The method of claim 1, wherein detecting the condition comprises:
detecting a delay in an acknowledgement message from the wireless device.

6. The method of claim 1, wherein adjusting the EDCA parameter comprises:
adjusting a contention window parameter for the wireless device.

7. The method of claim 6, wherein adjusting the contention window parameter comprises:
adjusting a maximum contention window size for the wireless device.

8. The method of claim 6, wherein herein adjusting the contention window parameter comprises:
adjusting a minimum contention window size for the wireless device.

9. The method of claim 1, wherein adjusting the EDCA parameter comprises:
adjusting an arbitration interframe spacing (AIFS) parameter for the first wireless device, wherein the AIFS indicates a period of time between a first transmission and a second transmission by the first wireless device.

10. The method of claim 9, wherein the AIFS parameter comprises an arbitration interframe space number (AIFSN).

11. The method of claim 1, wherein adjusting the EDCA parameter comprises:
providing the adjusted EDCA parameter to the wireless device; and
the method further comprising providing a second adjusted EDCA parameter to a third wireless device, wherein the second adjusted EDCA parameter is different from the adjusted EDCA parameter.

12. The method of claim 1, further comprising:
modifying, based at least in part on the detected condition, a short interframe space (SIFS) bursting parameter associated with the wireless device.

13. A communication device for wireless communication, comprising:
a delay condition detector to detect a condition indicative of a delay in reverse link throughput with respect to forward link throughput associated with a first wireless device; and
an EDCA parameter coordinator to adjust, based at least in part on the detected condition, an enhanced distribution channel access (EDCA) parameter associated with a wireless device selected from a group consisting of: the first wireless device and a second wireless device.

14. The communication device of claim 13, wherein the delay condition detector detects the condition by:
monitoring a size of a transmission queue associated with the first wireless device, wherein adjusting the EDCA parameter is based at least in part on the size of the transmission queue.

15. The communication device of claim 13, wherein the delay condition detector detects the condition by:
detecting a delay in an acknowledgement message from the wireless device.

16. The communication device of claim 13, further comprising:
a contention window manager to adjust a contention window parameter for the wireless device.

17. The communication device of claim 13, further comprising:
an arbitration interframe spacing (AIFS) manager to adjust an AIFS parameter for the first wireless device, wherein the AIFS indicates a period of time between a first transmission and a second transmission by the first wireless device.

18. An apparatus for wireless communication at a wireless device, comprising:
means for detecting a condition indicative of a delay in reverse link throughput with respect to forward link throughput associated with a first wireless device; and
means for adjusting, based at least in part on the detected condition, an enhanced distribution channel access (EDCA) parameter associated with a wireless device selected from a group consisting of: the first wireless device and a second wireless device.

19. The apparatus of claim 18, wherein the means for detecting the condition comprises:
means for detecting a delay in an acknowledgement message from the wireless device.

20. The apparatus of claim 18, wherein the means for adjusting the EDCA parameter comprises:
means for adjusting a contention window parameter for the wireless device.
